(19) United States
(12) Patent Application Publication
(10) Pub. No.: US 2026/0252217 A1
(43) Pub. Date: Aug. 27, 2026

(54) User Input Interface

(71) Applicant: Nes Irvine, Letchworth (GB)

(72) Inventor: Nes Irvine, Letchworth (GB)

(21) Appl. No.: 19/552,852

(22) Filed: Feb. 27, 2026

(30) Foreign Application Priority Data
Feb. 27, 2025 (GB) GB2502896.0

(51) Int. Cl. G06F 3/0484; G06F 9/451

(52) U.S. Cl. CPC G06F 3/0484; G06F 9/451

(57) ABSTRACT

A device having a graphical user interface (GUI) is disclosed, the device comprising a processor, memory storing executable instructions, and a display component. Control authority over GUI operation is transferred from manufacturer defined operating system instructions to user defined control. Existing GUI operating system instructions are made totally inoperative as a control authority, placing the device into an inoperative as GUI state in which no GUI operation can occur. GUI operability is restored only upon receipt of specific instructions provided by a user as input data, without reliance on any GUI operating system instruction to interpret, dispatch, or execute GUI operations. The device executes user defined configurations governing visual appearance, input interpretation, and execution of one to all GUI operations. All GUI operations are executed in accordance with the user defined instructions, and manufacturer control authority is not restored, across multiple device types and input modalities.

### PRIORITY CLAIM

This application claims priority to UK patent application GB 2502896.0 filed 27 Feb. 2025.

For the avoidance of doubt, the original Claim 1 of the priority application, now filed as Claim 1 of the present specification, should be interpreted by a person skilled in the art as fully including the scope and clarification expressed by the following formulation, which is provided solely to make explicit what is already implicit to the skilled person and to prevent misunderstanding by non-skilled readers:

A method for operating a device having a graphical user interface, the device comprising a processor, a memory storing executable instructions, and a display component, the method characterized by:
(i) making existing graphical user interface operating system instructions that interpret user input and trigger graphical user interface operations totally inoperative as a control authority, thereby placing the device in an inoperative graphical user interface state; and
(ii) receiving specific instructions provided by a user as input data, and, without requiring any existing graphical user interface operating system instruction to interpret, dispatch, or execute graphical user interface operations as a control authority, executing the specific instructions to configure and make operative one or more, including all, graphical user interface operations of the device.

For the avoidance of doubt, in current Claim 1 in the claims, the phrase ‘thereby making the device inoperative’ refers to an inoperative-as-GUI state, while non-GUI device instructions may remain operative, and the user (being the single controlling user under the UII principle).

This formulation does not introduce any requirement or limitation beyond those already recited in Claim 1, but serves only to articulate, in explicit technical terms, the interpretation that a skilled person would attribute to the wording of Claim 1 of the priority application as filed.

In the embodiments described herein, single-user control of the device is established by specific instructions provided by the user, such as user-defined gesture-based control or other deliberate input grammars, rather than by default graphical user interface operating system behaviour. In some embodiments, additional identity-related data may be provided by the user as part of the specific instructions to further distinguish the controlling user and enhance security; however, such identity verification is optional and is not required by Claim 1.

### Skilled-Person Mapping of Priority Claim 1 (Non-Limiting Clarification)

While some user-provided input of data is always required to operate graphical user interface functions under Claim 1, the particular form of such input data—including identity-related data—is user-defined and embodiment-dependent, and may be mandatory in some embodiments and omitted in others; however, the user-provided specific instructions include at least configuration sufficient to make operative one or more graphical user interface operations, whether minimal or extensive.

Interpretive clarification. If any description, embodiment, or figure is read as implying that Claim 1 or the invention requires a specific type of user-provided input data—identity-related data or a particular type, format, or extent of configuration data—as mandatory rather than as an embodiment of user-provided specific instructions, the correct interpretation is that such data is optional and embodiment-dependent, and that Claim 1 requires only that some user-provided input of data be supplied to operate graphical user interface functions, without limiting the form of that input.

### Definition of User Input Interface (UII)

As used herein, a “user input interface” refers to any technical interface by which a user provides input data or specific instructions to a processor of a device. The user input interface may comprise one or more input components, including, for example, a touch-sensitive display or touch component, a keyboard, a mouse, a trackpad, a stylus, or other user-operable input component. The user input interface enables a user to provide specific instructions to control one or more, including all, operations of a graphical user interface, wherein such graphical user interface operations are performed without control by pre-installed graphical user interface operating system instructions. The user input interface is not limited to a particular display configuration or graphical user interface state.

### Technical Field

The present disclosure relates to graphical user interfaces (GUIs) for electronic devices. In particular, the disclosure relates to a user input interface (UII) that changes the governing principle by which a device becomes operative as a GUI. The disclosure applies to devices having a processor, memory, a display component (which may include a touch-sensitive display), and one or more input components, including but not limited to touch sensors, physical keys, keyboards, mouse devices, stylus interfaces, microphones for voice input, biometric sensors, and external peripheral interfaces.

The disclosure is directed to the operational principle that determines which instructions have control authority to interpret user input and to trigger GUI operations. It is not directed merely to the visual design, iconography, layout, theming, restriction, or customization of a GUI layered on top of an already-operative operating system. Rather, the disclosure establishes an architecture in which the device is initially inoperative as a GUI until user-provided specific instructions—expressed as input data—restore GUI operability.

### Background and Problem Statement

Conventional GUI operating systems implement a manufacturer-defined set of “existing instructions” that interpret user input events (for example, taps, gestures, key presses, pointer movement) by reference to the graphical appearance of a display and then dispatch GUI events or trigger GUI operations. In those systems, the device is operative as a GUI by default, and the mapping between input events and operations is determined by manufacturer-defined semantics.

In such conventional systems, a user can often change superficial aspects of appearance and can sometimes configure preferences or shortcuts; however, those changes occur within a framework where manufacturer-defined instructions remain the governing authority at the point of execution. The device remains operable according to the same basic event interpretation and dispatch pipeline. As a result, the user cannot obtain exclusive control authority over how GUI inputs are interpreted or how GUI operations are executed.

The inventor recognized that this conventional paradigm creates structural constraints and shared attack surfaces. When large populations of devices share common instruction pipelines for input interpretation and GUI operation dispatch, those common pipelines can become a target for exploits that depend on predictable system behavior. Even where a manufacturer issues updates, those updates typically preserve broad portions of the underlying execution pipeline for compatibility, reliability, or ecosystem continuity.

Accordingly, the inventor identified a technical problem: how to provide a device that is not operative as a GUI under manufacturer-defined semantics and that becomes operative as a GUI only under user-defined semantics, so that GUI operability and GUI operations are controlled exclusively by user-provided specific instructions.

### Single Governing Principle of Operation

The present invention implements a change in the principle of operation of a device having a GUI. The principle change is that the control authority for GUI operability, input interpretation, event dispatch, and GUI operation execution is transferred from manufacturer-defined existing GUI operating system instructions to user-defined specific instructions provided as input data.

In accordance with the governing principle:
(1) Existing instructions of an existing GUI operating system that are responsible for GUI operability—namely, those instructions that interpret user input relative to the graphical appearance of the display, dispatch GUI events, or trigger GUI operations—are made totally inoperative as a control authority. As a consequence, the device becomes inoperative as a GUI. In this inoperative-as-GUI state, no tap, gesture, key press, pointer movement, or other input can cause any GUI operation to occur under existing GUI operating system semantics.
(2) GUI operability is restored only through specific instructions provided by a user as input data, without requiring any existing GUI operating system instruction to interpret, dispatch, or execute GUI operations as a control authority. In some embodiments, user-provided specific instructions include configuration data and identity data, and operability is restored when any user-defined identity requirements are satisfied and one, more, or all GUI operations are executed exclusively in accordance with the user-provided specific instructions.

The invention therefore establishes an architectural precondition: total inoperability of existing GUI operating system instructions that define manufacturer semantics is required before user-defined semantics can be exclusive.

### Definitions and Scope Clarifications

Existing instructions: instructions of an existing GUI operating system that define how a user makes the device operative as a GUI under that operating system. Such existing instructions include instructions that (i) interpret user input in relation to the graphical appearance of a display; (ii) dispatch GUI events; and (iii) trigger GUI operations.

Specific instructions: instructions provided only by a user as input data and operative to configure and execute one to all GUI operations when the device is inoperative as a GUI under existing instructions.

GUI operation: an operation available through a GUI, including launching or switching applications, navigating screens, selecting or entering data, initiating communications, retrieving or storing information, controlling device functions accessible through a GUI, or performing other user-level actions.

“One to all GUI operations” clarifies that the user-defined instruction set may configure a single operation, a subset of operations, or a complete set of operations, while still adhering to the governing principle that any operative GUI semantics are derived from user-defined specific instructions.

Inoperative as a GUI: a device state in which no GUI operation occurs under manufacturer-defined GUI operating system semantics because the existing instructions that would otherwise interpret input and trigger GUI operations are totally inoperative as a control authority.

Non-GUI device instructions: instructions relating to device functions that do not define how a user interacts with graphical content on a display, including power management, charging, internal comparisons or validation, data storage, hardware enablement, cryptographic operations, and diagnostic routines.

Control authority: the effective governing interpreter at the point of execution that determines whether, when, and how an input event triggers a GUI operation.

Control authority exclusivity: the property that GUI input interpretation and GUI operation execution cannot be simultaneously governed by independent, competing instruction sets at the point of execution without conflict. Accordingly, exclusive user control requires that manufacturer-defined GUI-operability control authority be made totally inoperative.

### Overview of System Architecture

A device implementing the invention includes at least: (a) a processor communicatively coupled to memory; (b) a display component (which may be touch-sensitive); and (c) one or more input components. The device further includes an instruction control boundary separating (i) non-GUI device instructions (e.g., power, charging, internal validation) from (ii) GUI-operability instructions that interpret inputs relative to display appearance and trigger GUI operations.

As used herein, memory includes one or more non transitory computer readable storage media storing executable instructions, configuration data, identity data, or combinations thereof. Non transitory computer readable storage media include, by way of non-limiting example, semiconductor memory, flash memory, solid state storage, magnetic storage, optical storage, or other tangible storage media, and exclude transitory propagated signals.

In one non-limiting embodiment, user provided specific instructions may be supplied to the device via a wired interface, such as a USB C connection, for example by connecting an external storage device or accessory that presents configuration data or identity data to the processor while existing graphical user interface operating system instructions remain inoperative as a control authority.

The invention modifies the device's operational pipeline such that existing GUI-operability instructions are made totally inoperative as a control authority. This yields a deterministic inoperative-as-GUI state. In that state, the device may remain powered and may detect inputs; however, those inputs have no operative GUI effect unless and until a user provides specific instructions as input data, and, optionally where identity validation is employed, the device validates that user-defined identity requirements are met.

Upon satisfaction of user-defined configuration requirements and, where identity validation is employed, user-defined identity requirements, the device executes GUI operations under user-defined semantics. In some embodiments, user-defined semantics may emulate prior-art GUI behaviour without restoring manufacturer-defined control authority.

The architecture is not limited to any particular display technology. The display component may include OLED, LCD, e-ink, microLED, projected displays, or other technologies. The architecture is also not limited to any particular input modality. The governing principle applies wherever existing GUI-operability instructions would otherwise interpret input relative to graphical appearance and trigger operations.

### Where the Principle Change Occurs (Control Authority Interposition)

In conventional systems, a user input event enters a pipeline that includes: input sensing; event creation; event dispatch; GUI framework interpretation; and operation invocation. The governing authority is typically the GUI operating system and its frameworks.

In the present invention, the principle change occurs by interposing a control boundary such that the manufacturer-defined GUI-operability instruction pipeline no longer functions as a control authority. The interposition point can be implemented at one or more of the following non-limiting locations:
(a) at event dispatch, where existing instructions would route input events to GUI frameworks;
(b) at GUI framework interpretation, where existing instructions would map an input event to a GUI operation based on display context;
(c) at operation invocation, where existing instructions would call an operation handler.

Regardless of where interposition is implemented, the required outcome is that existing GUI-operability instructions are totally inoperative as a control authority for GUI operations. Once inoperative, the device enters an inoperative-as-GUI state, and GUI operability can only be restored through user-provided specific instructions.

This interposition may be implemented by disabling execution of existing instruction pathways, by redirecting control flow to a minimal user-instruction execution environment, by gating event dispatch behind user-defined enablement conditions (including optional identity validation where such validation is employed), by disabling or bypassing a window manager or compositor input routing, or by other mechanisms achieving the same functional result.

### Making Existing GUI-Operability Instructions Totally Inoperative

The phrase “made totally inoperative” refers to functional inoperability as a control authority. It is not required that bits be erased or that the manufacturer-defined operating system be physically removed from storage. Instead, it is required that, in the operative condition of the invention, the manufacturer-defined GUI-operability instructions cannot interpret user input under manufacturer semantics to cause GUI operations.

In various embodiments, total inoperability is achieved by one or more of the following non-limiting mechanisms:
(1) A gating mechanism that prevents the existing GUI event dispatch system from invoking GUI operation handlers.
(2) A control transfer mechanism that prevents existing GUI frameworks from receiving input events as operative events.
(3) A policy enforcement mechanism that blocks manufacturer-defined GUI semantics until user-defined enablement conditions are satisfied and user-defined semantics are active.
(4) A boot-time configuration that marks the GUI-operability instruction pathway as inactive, such that the device cannot present an operative GUI under manufacturer semantics.
(5) A runtime mechanism that ensures, after disablement, no residual manufacturer-defined instruction can regain control authority for interpreting input and executing GUI operations.

In all embodiments, the disablement is performed prior to restoring GUI operability through user-defined specific instructions.

### Inoperative Wait State and Input Neutrality

After existing GUI-operability instructions are made totally inoperative, the device enters an inoperative wait state with respect to GUI operation. In this state, the device may maintain power and may accept or detect inputs, but all inputs are neutral with respect to GUI operations. That is, taps, gestures, keys, pointer movement, and other events do not trigger GUI operations by default.

This input neutrality is a structural consequence of the governing principle. Because GUI control authority is removed from existing instructions, the device is not capable of interpreting conventional UI events under manufacturer semantics. As a result, operations cannot be triggered by accidental touches, spurious events, or default gestures. A detected event may be logged or compared for validation, but it does not result in a GUI operation.

In some embodiments, the inoperative wait state may still allow non-GUI device functions, such as showing a minimal non-interactive status indicator, maintaining charging behavior, managing storage, or performing internal comparisons. However, such non-GUI functions do not constitute GUI operation semantics and do not restore manufacturer-defined GUI control authority.

The inoperative wait state may persist indefinitely until valid user-provided input data is received. The state may also be entered or re-entered by user instruction (e.g., to lock down GUI operability), or by policy defined within user-specific instructions.

### User-Provided Input Data: Identity, Confirmation, and Configuration

In various embodiments, the user provides input data that includes configuration data and may further include (i) identity data and/or (ii) confirmation data. Identity data identifies the intended controlling user. Confirmation data provides an additional check that the identity data is being presented by the intended user, for example through a confirmatory action, sequence, or second factor. Configuration data defines operative semantics for GUI operation, including how inputs map to GUI operations.

Identity data may be any data chosen by the user and associated with the device, including but not limited to cryptographic keys, biometric references, pixel-value references from image data, character strings, numeric values, or combinations thereof. Configuration data may define visual appearances, input grammars, event mappings, operation execution rules, and policies for re-entry into the inoperative state.

In one embodiment, identity data is derived from one or more pixel values in a file, including RGBA32 or RGBA64 pixel data. The user-selected pixel values define a reference or key material that is stored in secure hardware or secure memory (e.g., a trusted module). Once stored, in one embodiment, subsequent user-provided inputs are compared against stored identity data, and GUI operability is restored only if the identity requirements are satisfied.

The identity mechanism is not limited to a specific sensor. In some embodiments, GUI operability is restored only if user-defined identity requirements are satisfied.

### Secure Storage and Validation (Non-Limiting Examples)

In some embodiments, identity data and/or configuration integrity data is stored in secure storage, such as a trusted platform module, secure enclave, or other tamper-resistant memory. Validation may include cryptographic verification, comparison against stored references, and/or integrity checks.

The secure storage component may store: (a) a hash of identity data; (b) one or more public keys; (c) encrypted configuration bundles; (d) policy rules for enabling GUI operations.

When user input data is presented, an internal validation function compares the received input data with stored reference data, for example by comparing received identity data with stored identity references in some embodiments. If the validation fails, the device remains inoperative as a graphical user interface. If the validation succeeds, the device may activate a user-defined instruction execution environment.

In some embodiments, validation includes a limitation on the number of failed attempts, a requirement for a time delay between attempts, or a requirement for a different confirmatory factor. Such policies can be user-defined as part of the specific instruction data.

These mechanisms do not restore manufacturer-defined GUI control authority; rather, they operate as internal non-GUI functions that condition the activation of user-defined GUI semantics.

### Specific Instructions: Delivery Channels and Formats

Specific instructions may be delivered to the device by any channel that presents input data to the processor. Non-limiting examples include external memory (e.g., USB-C storage), internal secure storage, a wired interface, wireless interface, a locally provisioned file, or other data-bearing mechanisms.

In one embodiment, specific instructions are stored in a user-provided file containing commands. The instruction format may define: (a) a user identity declaration and confirmation action; (b) one or more visual appearances or screen states; (c) input grammars defining what constitutes an input event under user semantics; and (d) operation mappings defining what operation is executed upon satisfaction of an input grammar.

Specific instructions may be modular. A module may define a subset of operations or a subset of the GUI, enabling incremental refinement and testing. Because the device is operative as a GUI only under user-defined specific instructions, a user may change the GUI operational semantics by changing the provided input data, without requiring a manufacturer update.

In further embodiments, the instruction format supports importing an emulation profile that reproduces prior-art behavior, and then layering user-defined differences. This enables backward compatibility while preserving exclusive user-defined control authority.

### Decoupling of Visual Appearance, Input Grammars, and Operations

A key technical consequence of the governing principle is that, once operability is restored under user-defined semantics, the mapping between (i) visual appearance, (ii) input events, and (iii) operations can be decoupled.

In conventional GUIs, visual elements often imply fixed operation semantics defined by existing instructions. Under the present invention, visual appearance is merely one optional aspect of user-defined configuration; operations may be triggered without dependence on a particular visual appearance. For example, an operation may be triggered by a user-defined reference value even when the display is off or when a particular screen state is not presented.

In certain embodiments, the user-defined configuration includes separate control constructs for: (a) controlling display appearance; (b) controlling input interpretation; and (c) executing GUI operations. This modular decomposition allows a user to design one or more visual appearances and to assign any input grammar to any operation.

Decoupling yields direct benefits: fewer steps for task completion, reduced accidental triggering, the ability to define operation triggers that are not discoverable from the visual appearance alone, and the ability to reduce processing overhead by eliminating unnecessary GUI transitions.

### Backward Compatibility via User-Controlled Emulation

The invention supports backward compatibility by allowing user-defined specific instructions to emulate prior GUI behavior. In such embodiments, the user-defined instruction set may implement event mapping and operation execution consistent with an existing operating system version, application behavior, or user interface convention.

Crucially, emulation occurs under user-defined control authority. Even when user-defined semantics reproduce expected prior-art behavior, the existing GUI operating system does not regain independent authority to interpret input and dispatch events. Any execution of prior-art functionality, if present, occurs only as a function invoked by user-defined specific instructions, and, where identity validation is employed, after successful identity validation, without restoring manufacturer-defined control authority.

This arrangement provides a technical consequence: the device can behave familiarly while remaining structurally governed by the new principle of operation. The user can decide when to emulate, when to deviate, and when to restrict operations.

### WYCIWYG Reference Inputs and Direct Operation Invocation

In one embodiment, the device supports a “What You Choose Is What You Get” (WYCIWYG) interface, in which a user selection of an input-of-data reference value directly triggers an operation or configuration.

A reference value may comprise at least one of a bit pattern, a pixel value, a numeric code, a character string, or other user-provided data, including data derived from a user-defined input to the device, such as a specific swipe, pointer movement, mouse drag, or other deliberate input path. Once presented, the reference value may cause the device to: (a) select a visual appearance; (b) select an input grammar; (c) invoke a graphical user interface operation; or (d) invoke a sequence of graphical user interface operations.

The WYCIWYG approach enables direct invocation of operations without requiring conventional navigation through manufacturer-defined GUI flows. A user can therefore define “single-step” operation triggers that replace multi-step sequences.

Because the interpretation of the reference value is controlled exclusively by user-defined specific instructions, the same reference value can select different behaviors on different devices or for different users.

### Modular Configuration, Testing, and Iterative Optimization

In various embodiments, user-defined specific instructions are modular. A module may define a particular screen state, a particular set of operations, or a particular input grammar. Modules can be developed and validated independently.

Because the device becomes operative as a GUI only under user-defined semantics, a user can iteratively improve the configuration without dependence on manufacturer updates. The device can also provide timing and feedback mechanisms to compare interaction efficiency between different user-defined mappings.

For example, a user can define a gesture that selects multiple entries in a grid, measure the time required to complete a task, and refine the mapping. Iterative optimization is therefore a consequence of user control authority and modular instruction formats.

In some embodiments, modules can be shared between users as data. Sharing can be subject to user-defined identity constraints and validation policies, ensuring that imported modules do not restore manufacturer-defined control authority.

### Consequential Benefits: Reduced Common Attack Surface

Because existing GUI-operability instructions are made totally inoperative as a control authority, the device does not accept default manufacturer-defined event semantics. This yields a direct technical consequence: attacks that depend on predictable GUI input interpretation, dispatch paths, or operation triggers are structurally impeded.

In addition, user-specific instruction data may vary across users and devices. The operational behavior of two devices with identical visual appearance can differ. Observation of the GUI appearance therefore does not reveal operative semantics, reducing the value of universally applicable exploit strategies.

The security benefits described herein are structural and architectural. They arise from removal of default manufacturer-defined GUI control authority and replacement with user-defined control semantics.

### Consequential Benefits: Privacy, User Sovereignty, and Data Minimization

By requiring user identity validation and user-defined instruction control for graphical user interface operations in some embodiments, the device may be configured to minimize data exposure pathways. For example, user-defined policies may require explicit confirmation before execution of operations that transmit data externally, may disable categories of operations, or may require one or more additional factors for sensitive actions.

Because the governing semantics are user-defined, the user can define a minimal operational surface appropriate for the user's context. This can include restricting background operations, restricting automatic permissions, and limiting what operations can occur without confirmatory actions.

Such privacy-oriented behavior derives from the change in principle: operations occur only insofar as they are enabled by user-defined specific instructions.

### Consequential Benefits: Efficiency and Reduced Steps

The governing principle enables a user to define direct mappings from input data to operations and to define compound interactions that combine navigation and execution. Tasks can therefore be completed in fewer steps than conventional GUIs that require navigation through manufacturer-defined interface flows.

A user may define shortcuts that invoke multi-step sequences as single reference inputs. A user may define input grammars that select multiple items at once. A user may define screen states that present information and accept action input without intermediate dialogs.

These efficiency benefits arise from the principle change: the user is not confined to manufacturer-defined event mappings and can redesign the input grammar at the point of execution.

### Consequential Benefits: Error Prevention and Accidental Trigger Reduction

Because inputs have no default operative effect in the inoperative existing instructions of the existing GUI OS state, and because the user can require confirmatory actions under user-defined semantics, accidental triggering of operations is reduced.

For example, a user can define a “browse only” state in which inputs navigate or highlight without executing operations, and a separate “execute” grammar that requires a confirmatory pattern. A user can require spatial separation between navigation and execution inputs. A user can define time-based confirmations or multi-factor confirmations.

These benefits derive from the ability to design input interpretation and operation execution independent of manufacturer semantics.

### Consequential Benefits: Accessibility and User-Specific Input Design

The invention enables users to define input grammars that match individual capabilities and preferences. For example, a user can assign actions to gestures that minimize strain, can reduce precision requirements, can map actions to external devices, or can define alternative input schemes.

Because the device is operative as a GUI only under user-defined semantics, accessibility is not limited to manufacturer-provided accessibility options. Instead, the user can define the entire mapping from inputs to operations.

In some embodiments, user-defined configurations can be shared within a community of users with similar requirements, subject to validation and identity policies.

### Non-Limiting Application Example: Grid/Table Task Menus

In one non-limiting embodiment, user-defined specific instructions configure the GUI as a grid or table in which rows correspond to items in a task and columns correspond to selectable options. A user may define input grammars enabling rapid data entry by sliding or swiping across multiple cells. The user may configure the grid to remain stationary while a selection gesture records multiple items in a single movement.

The grid configuration can support task completion in domains where structured data capture is important. For example, a set of rows may represent questions, observations, or checklist items, and columns may represent discrete response categories. A user-defined grammar can permit a single continuous movement to mark a sequence of responses.

Such a grid configuration yields technical consequences: reduced interaction time, reduced missed fields, and reduced cognitive switching between navigation and execution.

This application is enabled by the governing principle and does not alter the principle itself.

### BRIEF DESCRIPTION OF THE FIGURES

FIG. 1 illustrates a comparison between a device operating under a conventional graphical user interface (GUI) operating system and an identical device operating under the User Input Interface (UII) principle, highlighting the transfer of control authority.

FIG. 1A illustrates an exemplary method flow in which existing GUI operating system instructions are rendered inoperative as a control authority and GUI operability is restored exclusively through user-provided specific instructions.

FIG. 1C illustrates the control-authority relationship under the UII principle, showing that existing GUI operating system instructions have no independent control authority unless enabled through user-defined instructions.

FIG. 1D illustrates a non-limiting example of provisioning user identity and configuration data via an external interface while existing GUI operating system instructions remain inoperative as a control authority.

FIG. 2 illustrates a non-limiting example of user-provided input supplied as data independently of graphical user interface semantics.

FIG. 3 illustrates a User Input Interface (UII) builder environment in which a user defines visual appearance, input grammar, and execution of one to all graphical user interface operations under exclusive user-defined control.

FIGS. 4, 4A-4F illustrate a non-limiting, task-based workflow example demonstrating structured data capture, guided decision-making, confirmation, and execution of operations under exclusive user-defined semantics.

FIGS. 4G-4L illustrate further non-limiting system-level consequences of the UII principle, including completeness checking, prioritisation, follow-up workflows, configurable input methods, and rapid structured data entry.

FIG. 5 illustrates a non-limiting example in which user input is represented as fixed-width data values, demonstrating high-speed selection, large configuration capacity, and security arising from user-defined input semantics.

FIGS. 6A-6M collectively illustrate incremental examples of how a user may build, extend, and modify a User Input Interface (UII) using the UII builder. FIG. 6A shows a user-defined interface configuration for controlled interaction with displayed content;

FIG. 6B shows incremental interaction and editing functionality; FIG. 6C shows integration of structured or tabular content; FIG. 6D shows creation and editing of presentation content; FIG. 6E shows user-defined global functions accessible independently of interface state; FIG. 6F shows media capture and editing; FIG. 6G shows independent control of display state and GUI operability; FIG. 6H shows user-controlled emulation, redesign, and extension of existing GUI structures; FIG. 6I shows switching between user-defined configurations and emulated behaviour; FIG. 6J shows precision pointer-based interaction; FIG. 6K shows controlled interaction with network-based content; FIG. 6L shows additional user-defined input paths and interaction models; and FIG. 6M shows modular application functionality within a unified user-defined interaction environment.

FIG. 7 illustrates a non-limiting example of a medical task menu (PHQ-9) in which high-risk responses may be entered rapidly using swipe-based input under user-defined semantics.

FIG. 8 illustrates a non-limiting example of a structured, task-based workflow implemented at scale under exclusive user-defined control.

FIG. 9 illustrates a non-limiting example in which optional identity-related input data is used to distinguish a controlling user without restoring graphical user interface operating system control authority.

FIG. 10 illustrates an exemplary device architecture implementing the User Input Interface principle.

FIG. 11 illustrates an exemplary end-to-end operational flow corresponding to the device architecture of FIG. 10.

### DETAILED DESCRIPTION OF THE FIGURES

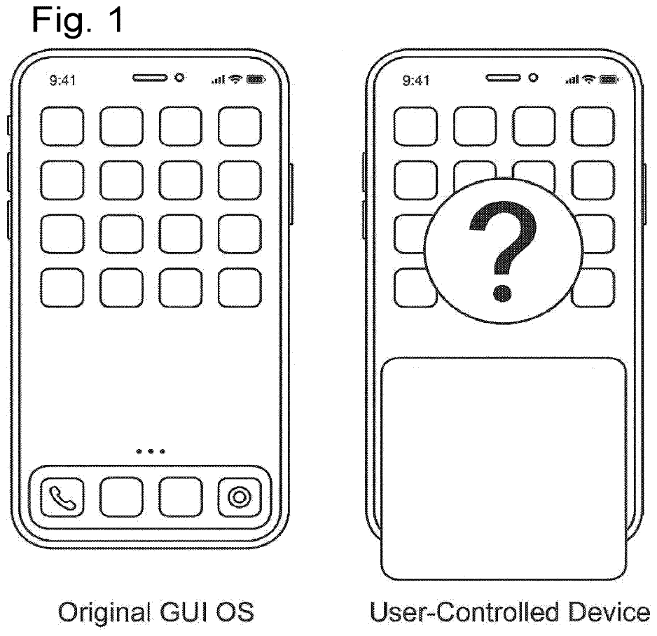

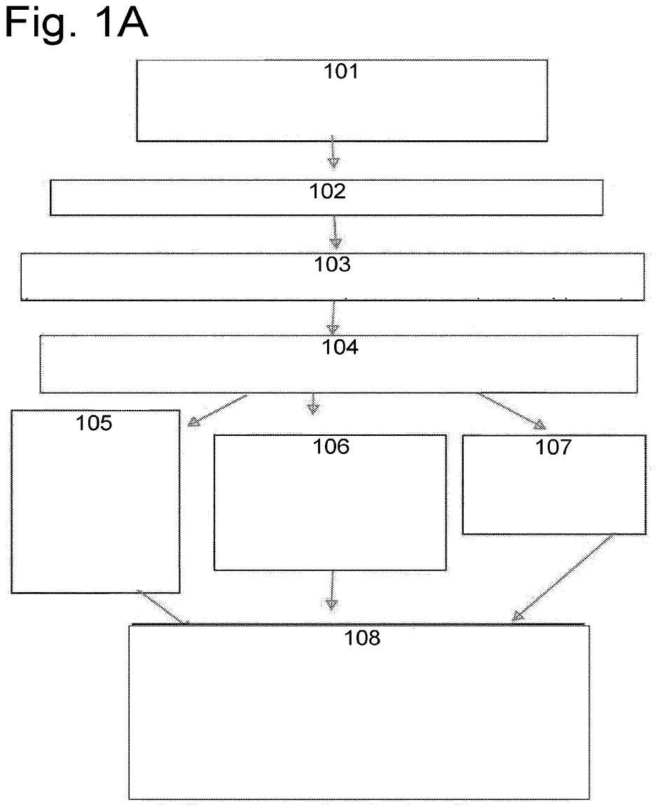

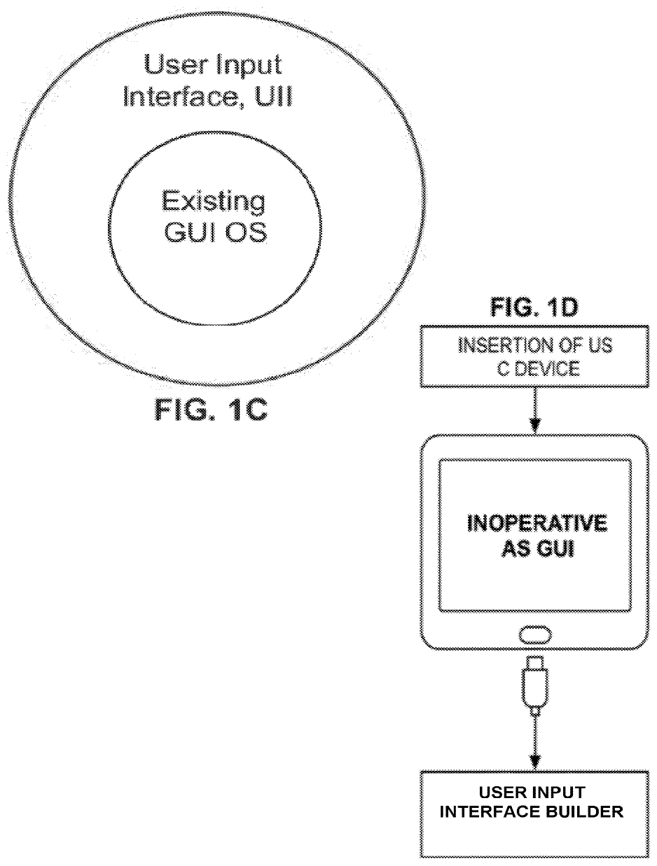

### FIG. 1—Comparison of Original GUI Operating System and User-Controlled Device

FIG. 1 illustrates a direct comparison between a device operating under a conventional graphical user interface (GUI) operating system and an identical device operating in accordance with the User Input Interface (UII) principle.

On the left side of FIG. 1, the device operates under an original, manufacturer-defined GUI operating system. Upon power-up, the device is immediately operative as a GUI, and user inputs are interpreted and executed according to pre-installed operating system instructions defined by the manufacturer.

On the right side of FIG. 1, an identical device is shown with the same visual screen appearance but operating according to the user-controlled principle of operation. Despite the identical appearance, existing GUI operating system instructions are rendered inoperative as a control authority, and the device remains in an inoperative-as-GUI wait state until the user provides specific instructions as an input of data. Once such user-provided specific instructions are received, graphical user interface operations are performed exclusively under user-defined control.

Technical significance: FIG. 1 demonstrates that identical visual appearances do not imply identical operability and that, under the UII principle, control authority over graphical user interface operation resides solely with the user rather than with manufacturer-defined operating system instructions.

### FIG. 1A—Method Flowchart for the User Input Interface (UII)

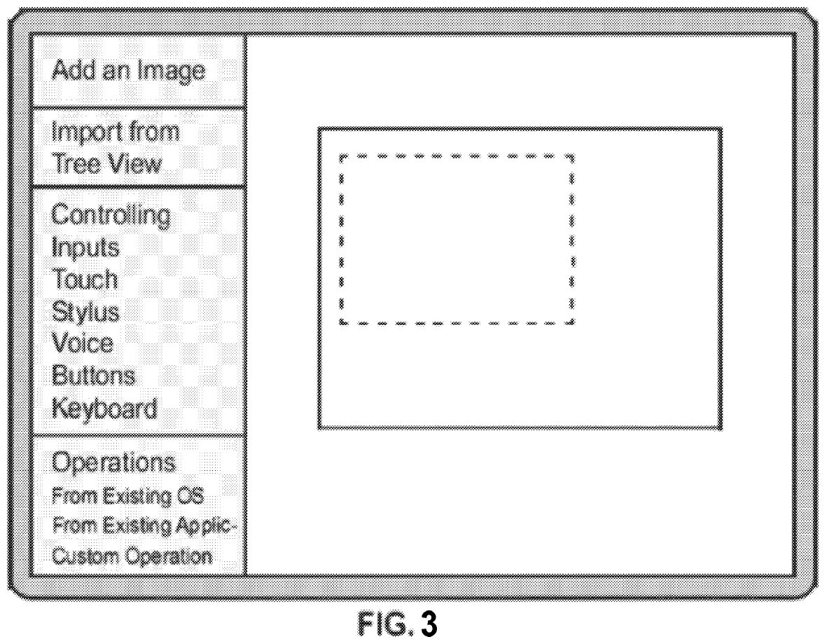

FIG. 1A illustrates a method for controlling a graphical user interface in accordance with the User Input Interface (UII) principle, for example as implemented using a User Input Interface builder such as that illustrated in FIG. 3.

In the illustrated method:
(101) existing graphical user interface operating system instructions are made totally inoperative, thereby rendering the device inoperative under manufacturer-defined control and placing the device into an inoperative-as-GUI wait state;
(102) a user provides a specific instruction by supplying an input of data to the processor;
(103) the user-provided input of data is received and recognised as user-defined data, without requiring any existing graphical user interface operating system instruction to interpret or enable the input;
(104) the processor processes the user-provided input of data to determine one or more graphical user interface operations in accordance with specific instructions defined by the user;
(105) a screen appearance is generated based on the user-defined instructions, which may emulate an existing graphical user interface appearance or present a new visual appearance;
(106) subsequent input events are interpreted exclusively according to the user-defined interpretation of input data;
(107) one to all graphical user interface operations are performed based solely on the user-provided specific instructions; and
(108) the graphical user interface is fully operative under exclusive user control, with all existing graphical user interface operating system instructions remaining inoperative as a control authority.

Technical significance: FIG. 1A illustrates the step-by-step transition from manufacturer-controlled inoperability to user-defined operability, without restoration of graphical user interface operating system control authority.

### FIG. 1C—Control-Authority Relationship Under the UII Principle

FIG. 1C illustrates, by way of a Venn diagram, that an existing graphical user interface operating system lies entirely within the scope of the User Input Interface (UII) and has no independent control authority unless explicitly enabled through user-defined specific instructions.

### FIG. 1D—USB-C Provisioning Under the User Input Interface (UII) Principle

FIG. 1D illustrates a non-limiting embodiment in which a device operating under the User Input Interface (UII) principle is provisioned and controlled using a USB-C interface.

In the illustrated state, existing graphical user interface operating system instructions are rendered totally inoperative as a control authority, placing the device into an inoperative-as-GUI state. Insertion of a USB-C device into the USB-C port constitutes an input of data rather than a graphical user interface interaction.

In one embodiment, the inserted USB-C device contains no pre-existing identity data. Upon user election to take control, the device generates a private user identity, for example by generating a random reference value, and stores the private identity in protected device memory. Optionally, a corresponding public key may be generated and, with user permission, written to the USB-C device.

Following identity establishment, the device provides access to a User Input Interface (UII) builder, as illustrated in FIG. 3. The UII builder operates while existing graphical user interface operating system instructions remain inoperative as a control authority and enables the user to define specific instructions governing visual appearance, operative inputs, and execution of one to all graphical user interface operations.

Configuration data generated by the UII builder may be stored on the USB-C device. Different USB-C devices may therefore correspond to different user-defined configurations, including configurations that emulate prior graphical user interface behaviour, configurations that restrict device operability, or configurations that render the device inoperative as a graphical user interface.

FIG. 1D therefore demonstrates that USB-C devices may be used to provision private user identity and to control device operability exclusively through user-provided specific instructions, without restoring control authority to existing graphical user interface operating system instructions.

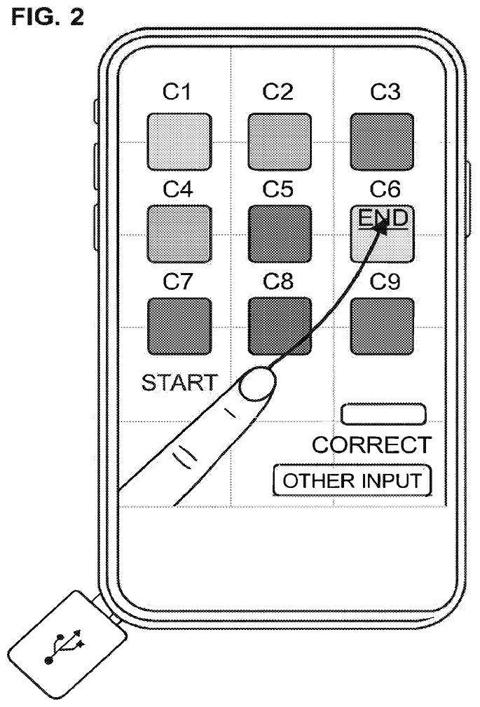

### FIG. 2—Swipe-Based Private Key Entry Using User-Defined Input of Data

FIG. 2 illustrates a non-limiting embodiment of a method by which a user provides a private key to a device using a touch-based gesture defined entirely by user-provided specific instructions. The figure shows a user initiating a swipe from an invisible region of the display—specifically a starting area located below and centrally relative to the visible screen—outside a visible grid of coloured regions, and terminating the swipe at a selected coloured region, such as region C6.

In one embodiment, a single swipe from the invisible start region to a selected colour region constitutes the entirety of the private key. In another embodiment, the private key comprises a sequence of such swipes, each terminating at a different colour region, thereby forming a user-defined sequence of input data values.

The swipe gesture is detected by the device as an input of data and is interpreted exclusively in accordance with specific instructions provided by the user, without reliance on any existing graphical user interface operating system instruction that would otherwise define the meaning of the gesture. The resulting input data is stored as the user's private key.

This approach is distinct from hardware-based authentication mechanisms, such as removable storage devices or physical tokens, in that it relies solely on user-performed input gestures and does not require the user to carry any external authentication object.

In some embodiments, the swipe-based private key may be used alone or in combination with biometric verification, such as fingerprint or facial recognition. In such embodiments, biometric verification may first confirm the presence of the user, after which the user performs the swipe gesture to define or confirm the private key, thereby providing a multi-factor authentication mechanism under user control.

The system supports multiple swipe gestures selecting different colour regions, where each colour may be referenced by a descriptive name (for example, “emerald”) and/or by a numerical value corresponding to its RGBA representation. For users with colour-vision impairment, each colour region may optionally display a numeric overlay, such as a 2×2 grid representing RGBA values, enabling selection by numeric input rather than colour perception.

The private-key input of data is not limited to a single interaction modality. The device may accept private-key-defining input via one or more user-defined methods, including swipe gestures selecting colour regions, textual entry of a colour name, numeric entry of RGBA values, hardware-button inputs, voice input, or any other input method available to the device. This flexibility enables the private key to be provided in a manner suited to the user's abilities and preferences while remaining independent of manufacturer-defined GUI input semantics.

Once the private key is established, a corresponding public key may be generated and optionally backed up to external storage, such as a USB-C device. Alternatively, the public key may be entered directly by the user using a similar colour-selection mechanism, for example by selecting one or more colours from a scrollable grid. In the illustrated embodiment, navigation through available colours is achieved by vertical swipe gestures in a column positioned separately from the main colour grid, reducing the likelihood of accidental selection during swipe initiation from the invisible region. The user may also select an alternative input option to enter public-key data via other available user-defined input methods.

FIG. 2 therefore demonstrates a user-controlled, non-limiting, and highly configurable authentication method based on user-defined interpretation of input data. A swipe gesture originating in an invisible region and terminating at a selected colour region defines a private key, either alone or in combination with biometric verification. The method supports multiple accessible input modalities, numeric and descriptive representations of colour data, and secure public-key backup, all without reliance on physical tokens or manufacturer-defined GUI input semantics, and is consistent with the user-input-driven principle of operation of the invention.

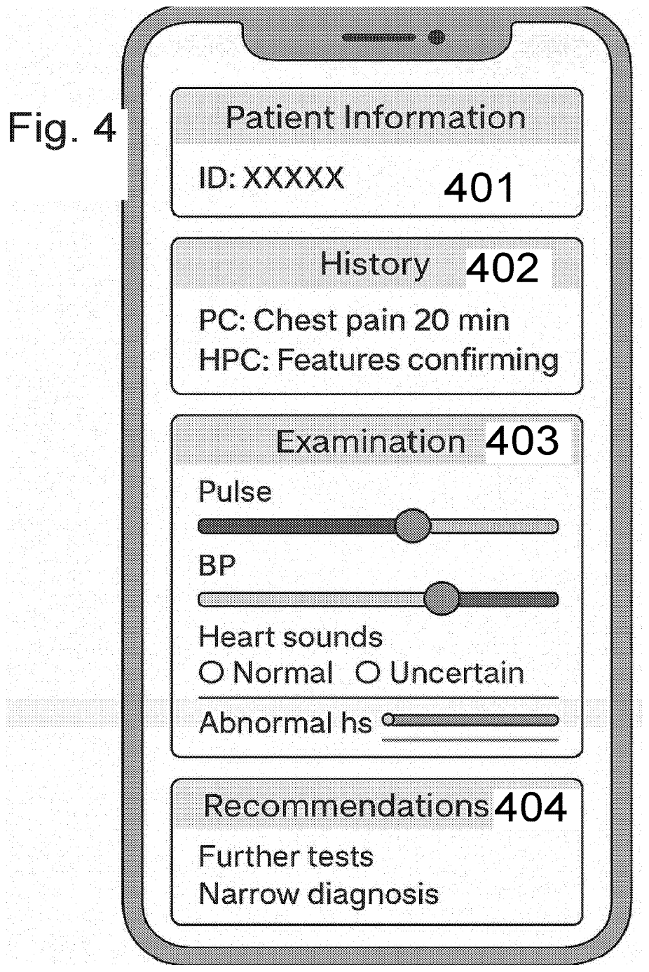

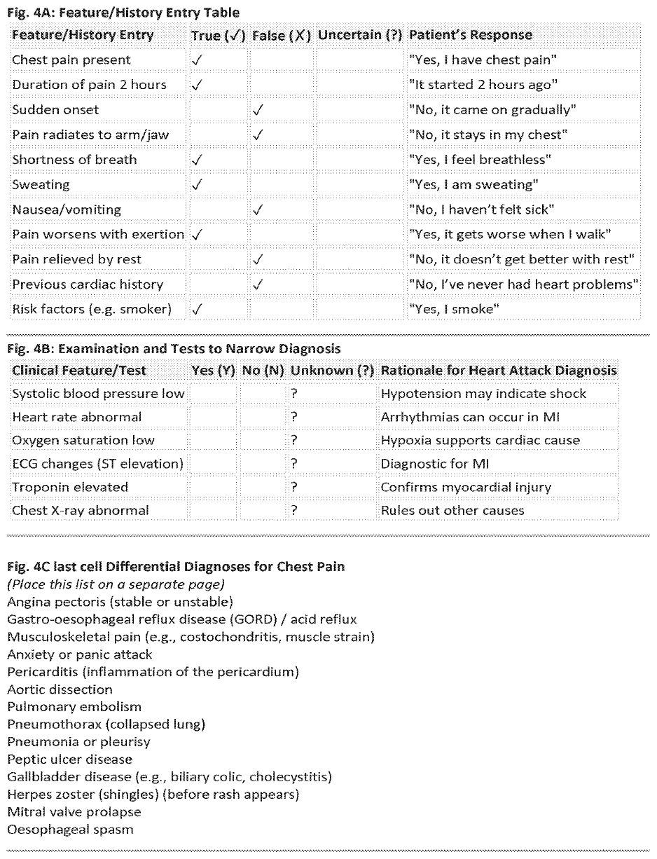

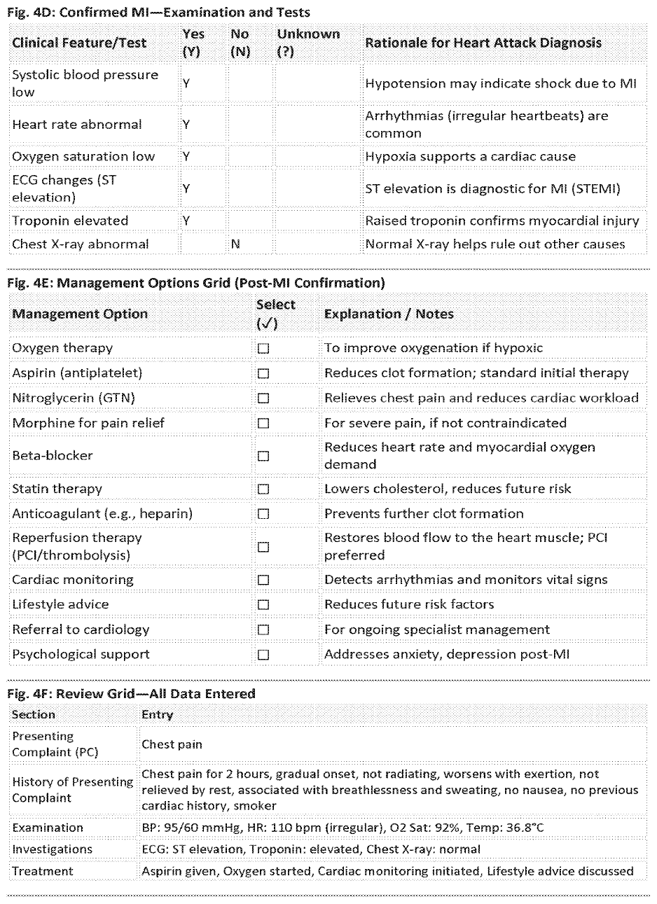

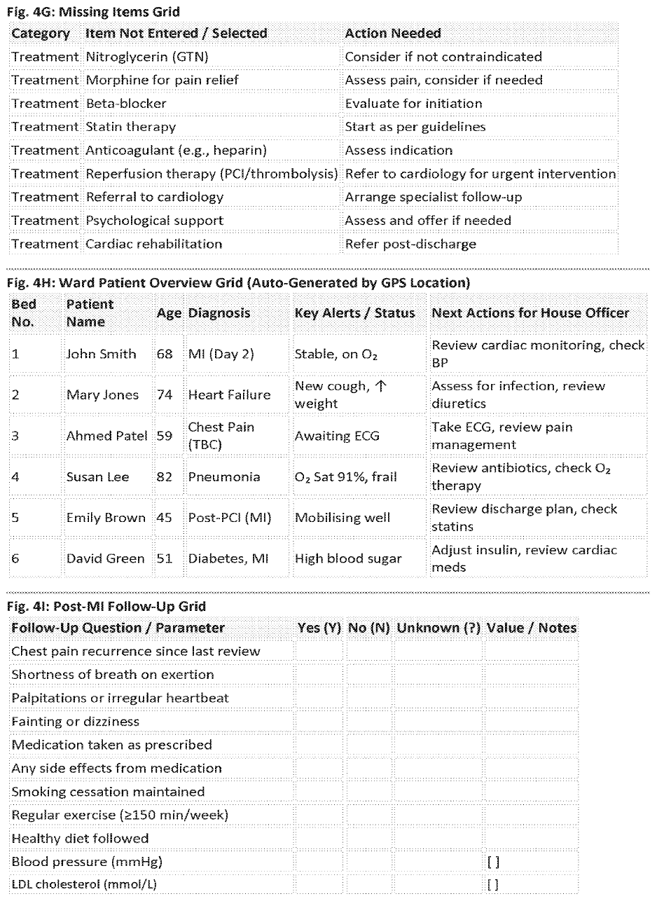

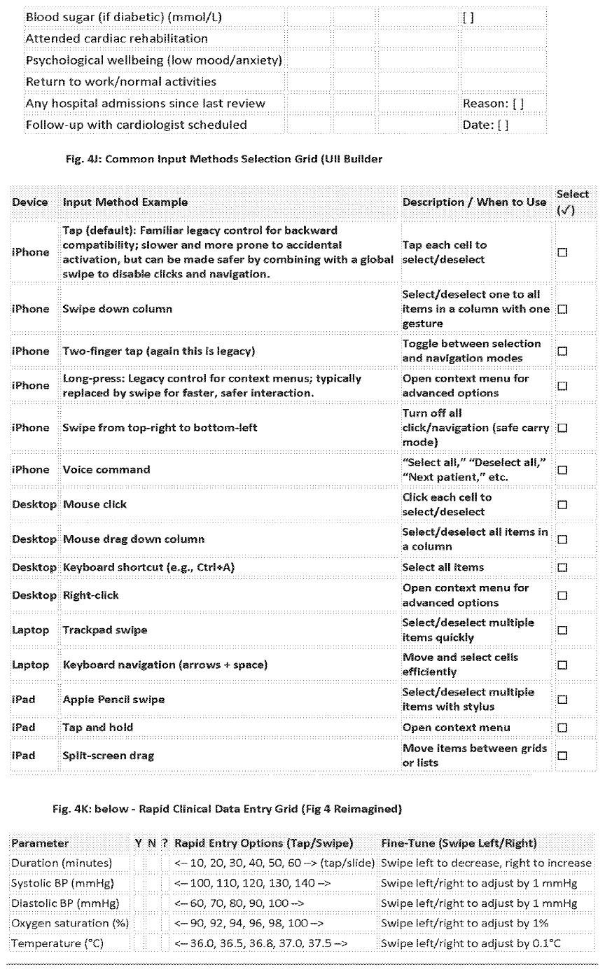

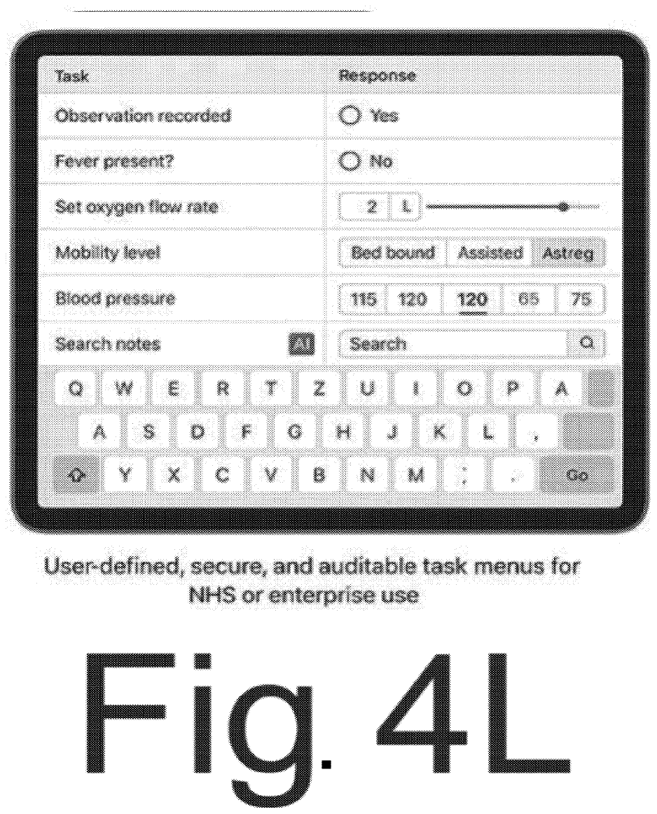

### FIG. 4—Example User-defined Multi-Region UII Configuration

FIG. 4 illustrates a non-limiting example of a user-defined User Input Interface (UII) configuration that is transferable across a mobile phone, tablet, laptop, or desktop computer, and that operates with existing graphical user interface operating system instructions rendered inoperative as a control authority.

In the illustrated configuration, the UII presents multiple concurrently visible interface regions, the layout, behaviour, and input semantics of which are defined entirely by user-provided specific instructions. Existing graphical user interface operating system instructions remain inoperative as a control authority, such that all interpretation of input and execution of graphical user interface operations occur exclusively under user-defined semantics.

401 a first interface region presents contextual or identifying information, such as patient, user, or task identification data. This region is informational and does not itself trigger operative actions.

402 a second interface region presents a scrollable narrative history derived from structured data previously entered elsewhere in the interface. As new data is entered under user-defined semantics, the narrative history is dynamically updated to reflect the evolving state of the task. Generation and updating of the narrative view are performed independently of any existing graphical user interface operating system instruction.

403 a third interface region comprises a vertically scrollable, grid-based task interface that forms the primary mechanism by which data is entered, reviewed, and progressed. Rows correspond to discrete data items, questions, observations, or task elements, while columns correspond to user-defined input mechanisms, including binary or ternary selectors (e.g. yes/no/uncertain), numerical sliders, and descriptive sliders defining qualitative ranges. The illustrated grid represents non-limiting examples of data entry mechanisms and may include strict row-and-column layouts or other scrollable arrangements fitting the available display space.

The grid is vertically scrollable such that downward scrolling provides access to previously entered rows for review, while upward scrolling reveals subsequent rows representing further data items to be entered. Where no explicit input is provided for a particular row, the corresponding data item is treated as an uncertainty value in accordance with a user-defined policy and may be flagged for subsequent confirmation.

The grid is configured to separate navigation from execution so as to reduce accidental activation of operations. For example, navigation through rows may be performed using a first region of the display, such as a column describing each item, operable by one digit of the hand, while entry of values is performed using a separate region, such as remaining columns of each row, operable by another digit. Navigation actions do not themselves trigger execution, and execution occurs only in response to explicit user-defined input grammars.

As data is entered into the grid-based task interface, corresponding information is automatically incorporated into the narrative history presented in region 402. This transformation from structured grid entries to narrative form is performed under user-defined semantics and does not rely on any existing graphical user interface operating system instruction.

404 a fourth interface region presents system-generated output produced in response to the structured entries made in the grid, such as dynamically updated interpretations, candidate classifications, suggested subsequent data items, or recommended follow-up actions generated by processing modules operating under user-defined control. As additional rows are completed, the content of this region is continuously updated.

The set of rows presented in the grid-based task interface is not static. As data is entered, additional rows may be dynamically introduced in accordance with the selected task configuration, including rows representing further required data items, follow-up observations, or externally obtained results. When results are received from external sources, such results may be automatically inserted into corresponding grid rows, and subsequent rows may be modified to guide completion of remaining task elements.

The grid structure represents one selectable task configuration chosen by the user as a set of specific instructions via a UII configuration environment. Task configurations may be pre-approved, shared, or further customised by the user through additional specific instructions, while remaining fully governed by the UII principle.

FIG. 4 therefore demonstrates how a single scrollable, grid-based interface can support compact, consistent, and complete task execution under exclusive user-defined control, while dynamically adapting to prior inputs and externally obtained results. All interaction, progression, and execution occur without reliance on existing graphical user interface operating system control authority and are executed exclusively in accordance with user-provided specific instructions.

### How FIGS. 4A-4F Demonstrate AI-assisted Confirmation and Management of Myocardial Infarction (MI)

### Overview

FIGS. 4A-4F illustrate a real-time clinical workflow in which a patient presenting with chest pain provides history directly to the system, and an AI-structured User Input Interface (UII) organises this information into a task-based grid. The clinician is guided through examination, investigation, differential diagnosis, confirmation of myocardial infarction (MI), and management using structured task menus. The figures demonstrate accurate MI diagnosis and management through consistent data capture, AI prompting, and efficient clinician interaction.

### Additional NHS and International Clinical Use Case—Eliminating Interface Fragmentation and Unsafe Workarounds

Clinicians frequently move between hospitals, particularly locum doctors, and are often unfamiliar with local computer interfaces. Under time pressure, this leads many clinicians to avoid electronic systems altogether, instead relying on handwritten notes that must later be transcribed. This introduces delay, error, and loss of data.

This behaviour arises from inconsistent, manufacturer-defined graphical user interfaces rather than from the clinical task itself. Identical clinical work is performed differently—or not at all—depending on the local system, creating avoidable risk across primary care, secondary care, and emergency departments.

The User Input Interface (UII) solves this technical problem by removing dependence on local GUI operating system behaviour. Under the UII principle, the existing GUI configuration of a local computer is rendered inoperative as a control authority. When a clinician presents their identity (for example via a badge, token, or other user-provided input of data), the device becomes operative according to that clinician's own predefined interface configuration, previously created using the UII builder.

As a result, a clinician arriving at a different hospital is immediately presented with their familiar task-based interface. Data is entered accurately and at full speed, eliminating the need for handwritten workarounds. Local systems continue to interact with NHS Spine services and hospital databases unchanged; only the appearance, input grammar, and task flow are controlled by the clinician's user-defined configuration.

This approach scales across the workforce, enabling clinicians, nurses, paramedics, and emergency staff to operate using interfaces tailored to their roles while remaining interoperable with all NHS systems. The same principle applies internationally: clinicians working abroad can use their familiar interface and language, with underlying data translated as required, allowing immediate safe operation in unfamiliar environments.

This effect arises directly from the change in principle of operation recited in Claim 1—removal of manufacturer GUI control authority and restoration of operability only through user-provided specific instructions.

### Illustrative Pandemic Detection and Early Isolation Scenario

Because UII enables consistent, task-based data capture across sites, early abnormal clinical patterns can be detected in real time. Clinicians or public health doctors may configure monitoring tasks to identify emerging symptom clusters. Detection arises from consistent data structure rather than retrospective aggregation of incompatible records, enabling earlier intervention without imposing additional reporting burdens.

As used herein, a task menu comprises a tabular grid in which rows represent a sequential list of task-relevant details and columns represent user-customisable methods for recording those details. In the myocardial infarction (MI) example, the rows progress from initial history through examination, investigations, and management, while the columns define how each item is most efficiently entered by a given clinician. This tabular grid structure is well suited to AI processing and to the implementation of best-practice protocols. Using the User Input Interface (UII), best-practice task menus may be rapidly designed for clinical conditions, with each clinician able to define their own method of interacting with the same underlying grid structure. AI-assisted task menus may incorporate evolving best-practice evidence and clinician-approved pathways to dynamically adapt subsequent rows toward the most likely diagnosis, with the MI workflow shown as a non-limiting example of a structure applicable to many clinical conditions. The objective is to reach diagnoses in fewer steps and with greater accuracy, while enabling NHS data to evolve as a collection of task menus covering a broad range of clinical conditions and patient-related tasks.

### FIG. 4A—Patient-Entered History Grid

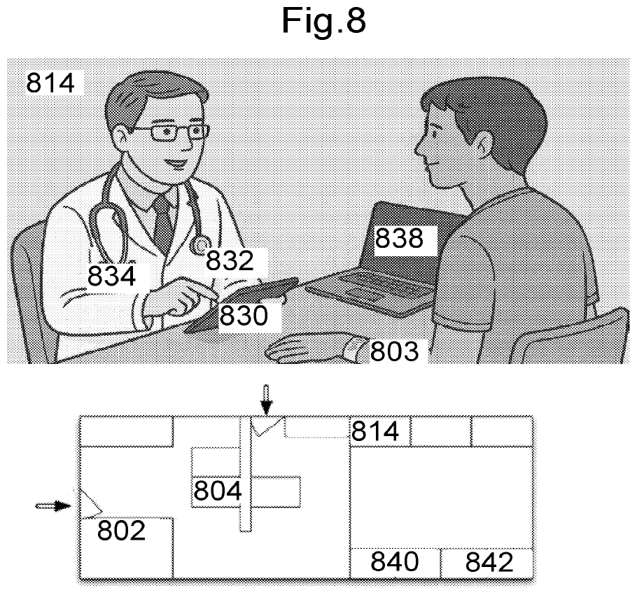

The patient provides symptom history (e.g. chest pain, duration, radiation, exertional nature). AI converts free text or speech into a structured grid, capturing symptoms and risk factors. A differential diagnosis row reflects possible causes based solely on patient-reported data. This also can be entered at step 804 in triage by a nurse in FIG. 8

Key point: MI suspicion is raised from history alone.

### FIG. 4B—Examination and Initial Tests Grid

The clinician 834 in FIG. 8 enters examination findings and initial investigations using simple categorical inputs. The differential diagnosis updates dynamically as objective data is added. Indeed having a tabular form means finger movements can go from one row to the next, and rest on the screen 832 in FIG. 8 maintaining eye contact with the patient. Alternatively a desktop or laptop 838 in FIG. 8 could be used.

Key point: MI is not yet confirmed, but diagnostic likelihoods are narrowed safely.

### FIG. 4C—Diagnostic Narrowing

Positive investigations (e.g. ECG changes, raised troponin) are entered as they arrive 814 from the lab 840 and blood tests 842 in FIG. 8. AI logic updates the grid, elevating MI above competing diagnoses.

Why MI is confirmed:
Ischaemic history
Objective examination
Positive investigations

### FIG. 4D—Management Options Grid

Once MI is confirmed, a task-based management menu is presented. Clinicians can select individual actions or swipe entire columns to select multiple treatments rapidly. Selection populates downstream systems automatically.

Key point: Management is fast, complete, and duplication is eliminated.

### FIG. 4E—Review and Confirmation

The clinician reviews the AI-generated summary with the patient. Any item may be corrected instantly.

Benefit: Produces a verified, auditable record.

### FIG. 4F—Final Confirmed Record

All history, findings, diagnosis, and management decisions are confirmed and timestamped.

Outcome: A complete, accurate, real-time MI record.

### Extensions in FIGS. 4G-4K—System-Level Impact

FIG. 4G: Missing-item grids prevent protocol omissions.

FIG. 4H: Ward-level prioritisation of urgent actions.

FIG. 4I: Long-term post-MI follow-up.

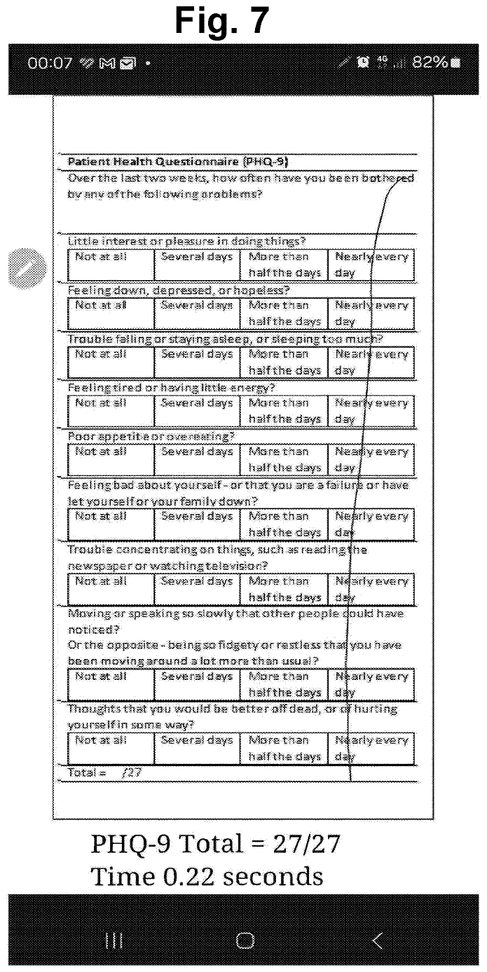

FIG. 4J: Customisable input methods via the UII builder enable users to design how they interact with task menus, including visual appearance, input grammars, and operation execution. As illustrated by FIG. 7, large communities of users—for example clinicians within the NHS—may act collectively as UII designers by refining task-menu configurations to improve data entry efficiency. A user may then take such a configuration and apply it to patient data interaction, such that the same configuration may be used across multiple devices while remaining tied to the user's device and, where employed, optional user identity. As a result, a user can interact with shared systems using their own user-defined interface configuration, independent of local graphical user interface operating system behaviour.

FIG. 4K: Rapid numeric and categorical data entry.

FIG. 4L: This shows text (mobility) and numerical horizontal sliders to enter BP, pulse, and a search which characters can be entered by a qwerty keyboard showing backward compatible emulation for familiarity for user, and Yes and No responses.

### Why This Confirms MI Using AI and Task Menus

MI confirmation results from structured collaboration:
1. Patient history→AI structuring
2. Clinician examination and tests
3. Objective results narrow diagnosis
4. Task-based management
5. Review and audit

AI supports, but does not replace, clinical judgement.

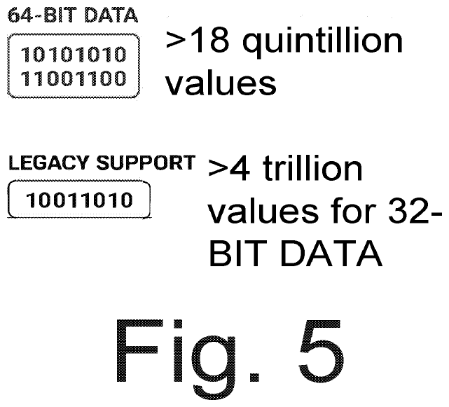

### FIG. 5—64-Bit Data Selection, Speed, and Security

User input may be represented as 64-bit data values, providing 2⁶⁴ possible inputs. A single user action can encode a unique value that is interpreted solely under user-defined semantics, independent of any existing GUI operating system input interpretation.

### Technical Effect

Maximum speed, through single-action selection
Maximum capacity, through an extremely large configuration space

This enables secure authentication, configuration selection, and control of one to all graphical user interface operations without reliance on manufacturer-defined GUI semantics.

### Security Model and Technical Effect

The invention changes the principle of operation of a GUI device. Existing GUI operating system instructions are inoperative by default, and operability exists only when valid user-defined data is present. Security is therefore achieved by absence of operability, rather than by restricting an otherwise operative system.

Because operative semantics are derived exclusively from user-provided specific instructions, there is no shared semantic attack surface. Identical devices operate differently under different user configurations, making replay, observation, and large-scale exploitation impractical.

### Optional Nature of Identity Data (Claim 7).

As reflected in Claim 7, identity-related data is optional because security under the User Input Interface (UII) arises directly from the user's exclusive control over operability through user-provided specific instructions supplied as input data. The device is inoperative as a graphical user interface by default, and only user-defined input data values have operative meaning. In embodiments using fixed-width data representations, such as 64-bit values, only one or a very small subset of the 2⁶⁴ possible values may correspond to an operative instruction, making unauthorised operation computationally impractical. Execution of even minimal functionality requires correct provision of the user-defined input data value for each operation in a sequence, without knowledge of the user's instruction mapping, causing the probability of successful unauthorised operation to decrease multiplicatively. The user may further define operative values using offsets, transformations, or reference positions within the data space, such that identical physical inputs or observed data values provide no predictive information. Accordingly, strong security is achieved per device and per user without requiring identity verification; identity-related data, when used, may further distinguish or validate a controlling user, but is not required to achieve security under the UII architecture described in Claim 1. Single-user control (a user) under Claim 1 is achieved through user-defined configuration data supplied as an input of data and bound to the device, without requiring identity verification.

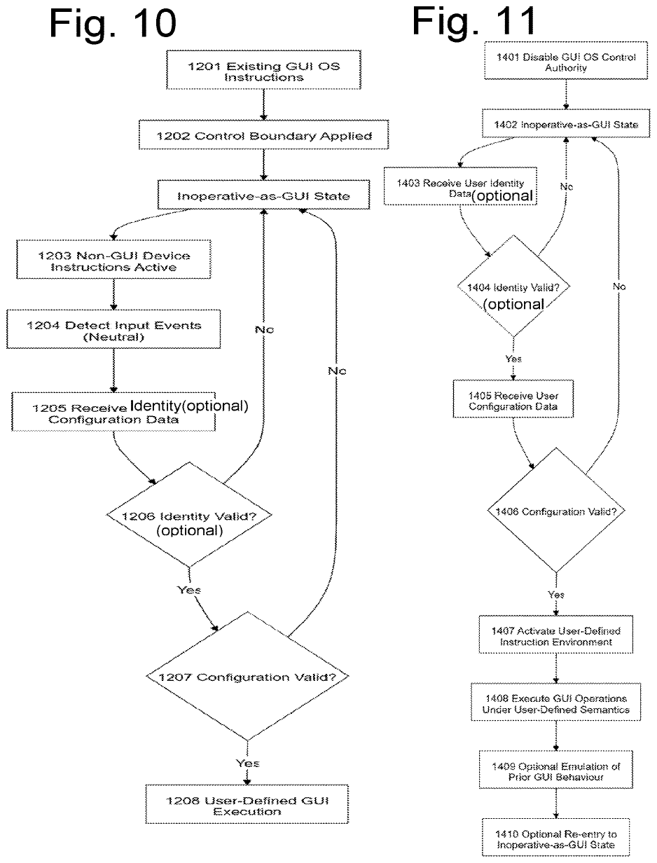

For the avoidance of doubt, FIGS. 10 and 11 illustrate an exemplary end-to-end workflow that includes optional identity checking, consistent with Claim 7. In embodiments implementing Claim 1 alone, elements of the workflow relating to identity checking are omitted, because identity validation is an optional enhancement introduced in Claim 7 and is not required by the governing principle of operation defined in Claim 1.

### Resistance to Replay and Observation Attacks

Observed input events have no operative meaning outside the user-defined instruction set. Identical physical inputs from different users do not produce the same result. Replay, spyware, and observation-based attacks fail because the mapping between input data and operation is unknown, user-specific, and non-inferable.

### Entropy and Performance

Validation of operability may be performed using fixed-width data comparisons (for example, 64-bit values), which are constant-time operations with negligible computational overhead. Security arises primarily from structural unknowability, rather than cryptographic complexity alone.

### Comparison With Prior Art

Unlike prior-art systems in which the GUI operating system remains continuously operative, the invention removes manufacturer control entirely. All execution of GUI operations occurs only through user-defined mediation, eliminating shared gestures, predictable event pipelines, privilege escalation paths, and universal exploits.

### Technical Advantage and Inventive Step

The invention establishes a user-controlled computing architecture in which operability, security, and predictability arise from deliberate user-defined input paths. This change in principle produces systemic technical effects—including absence of shared semantics and inoperative-by-default behaviour—that cannot be achieved by incremental modification of existing graphical user interface operating systems.

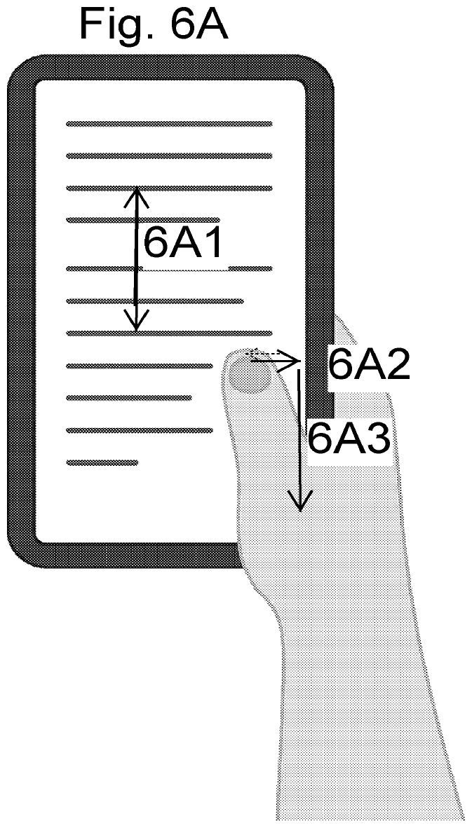

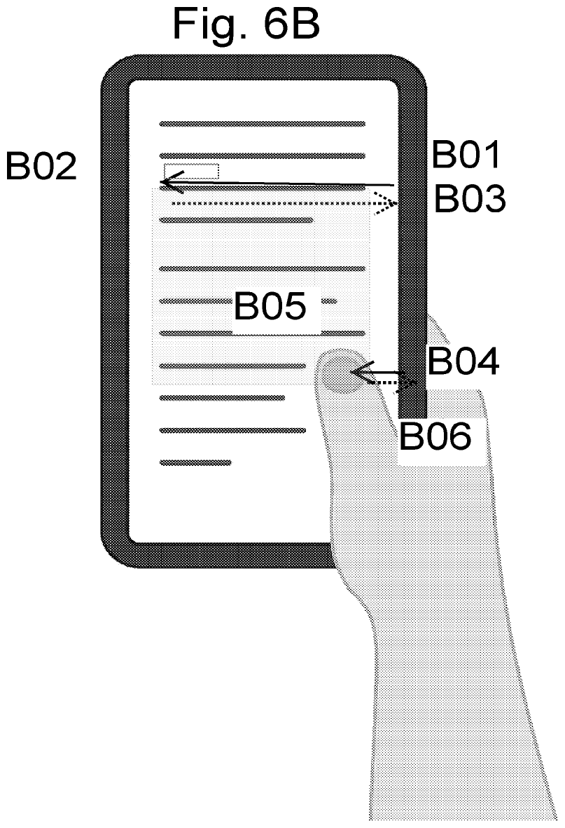

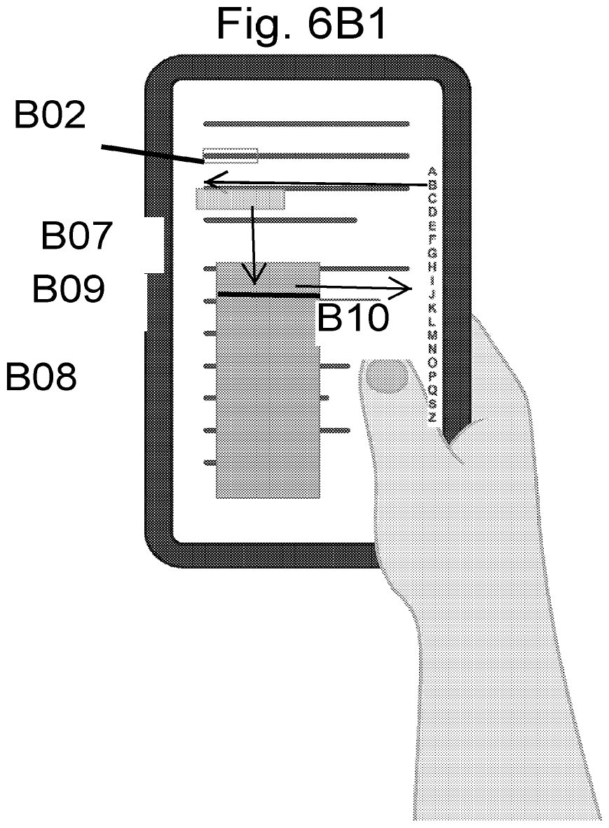

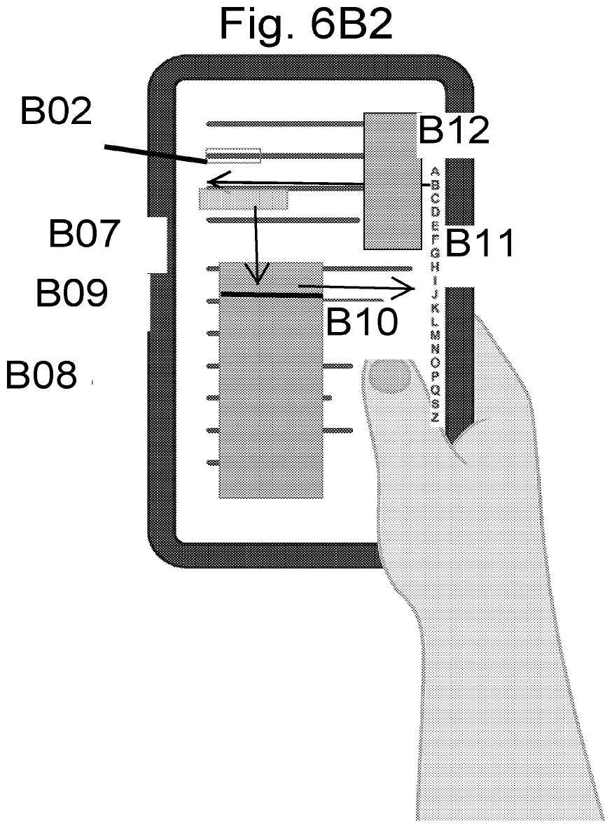

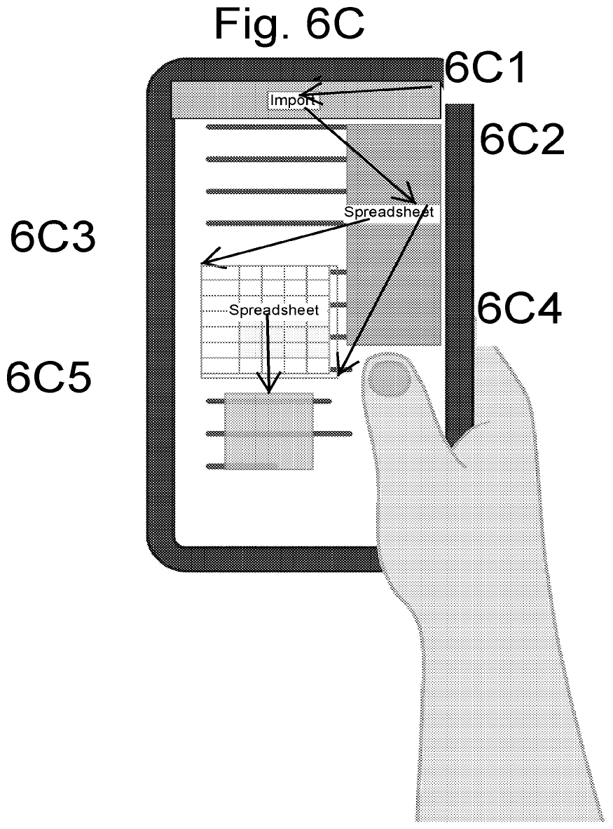

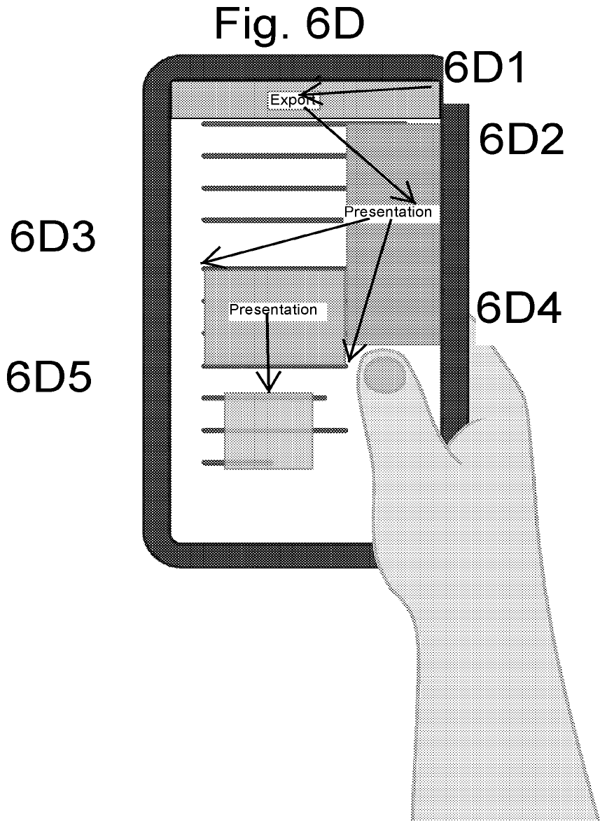

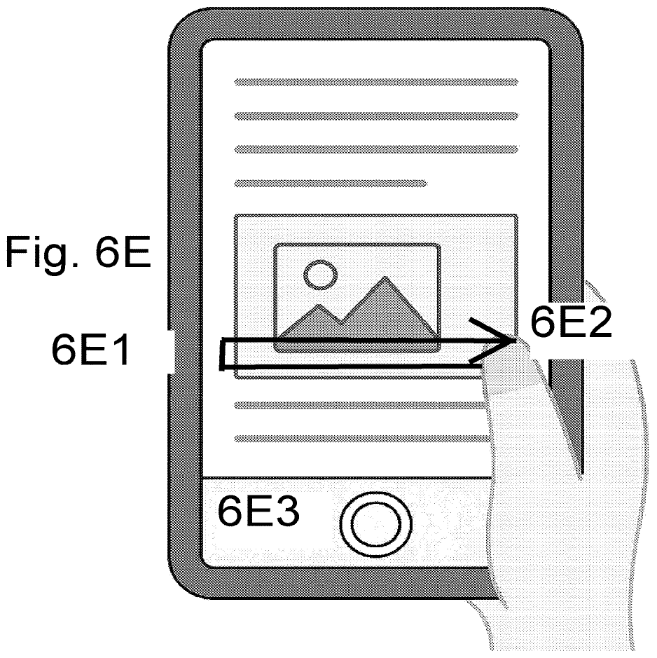

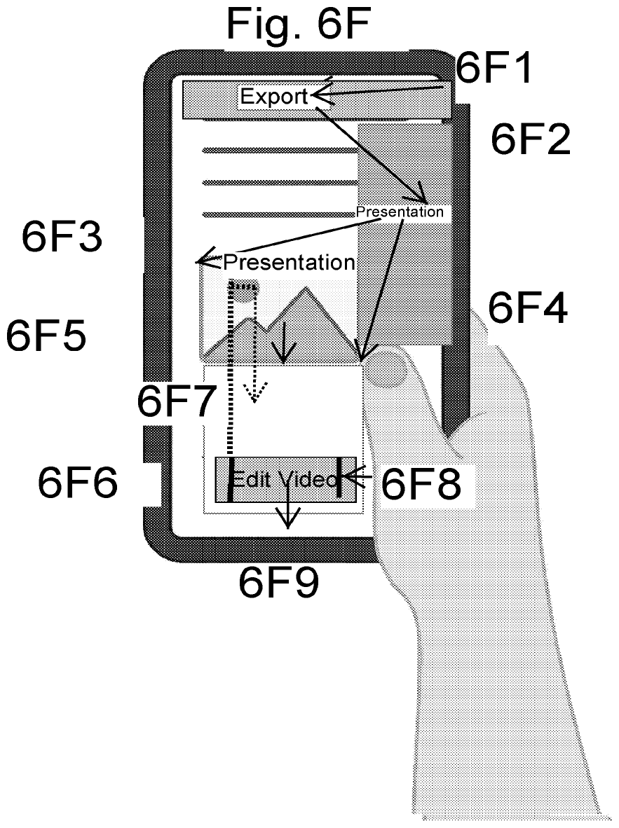

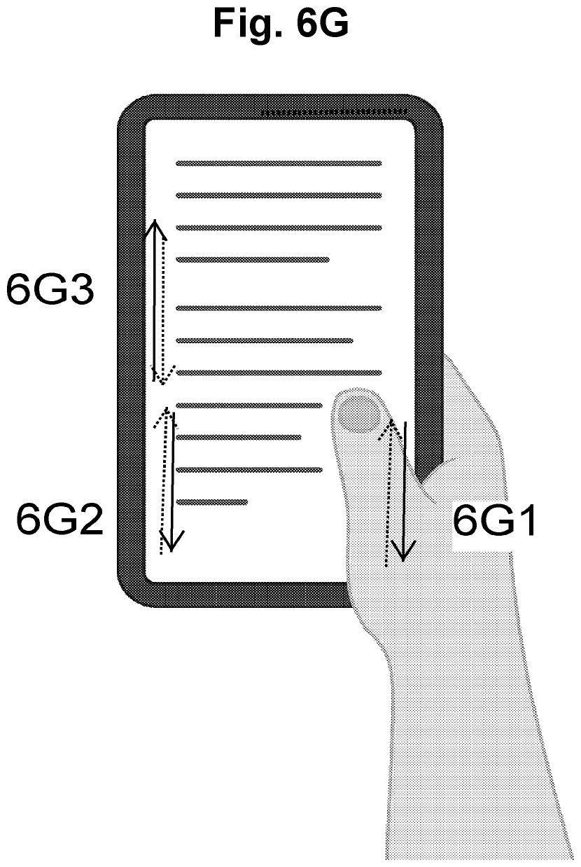

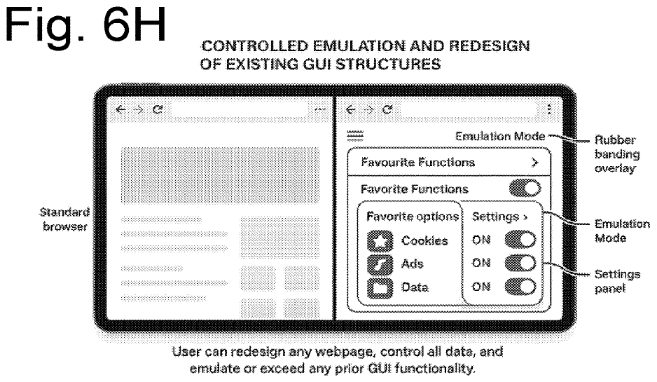

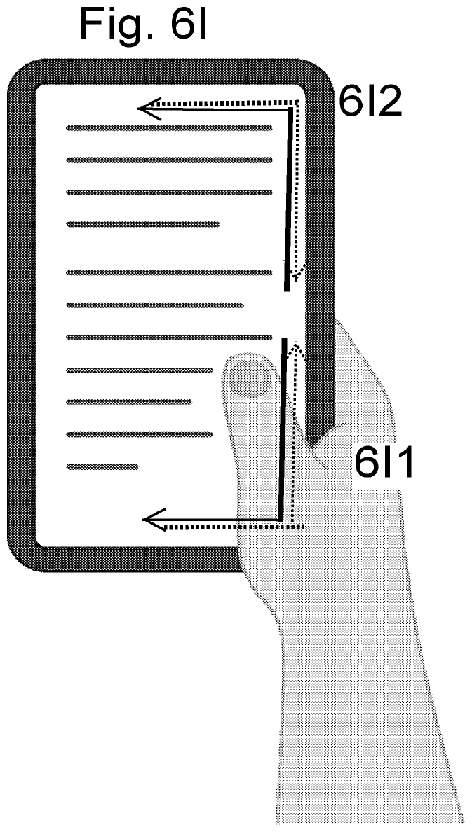

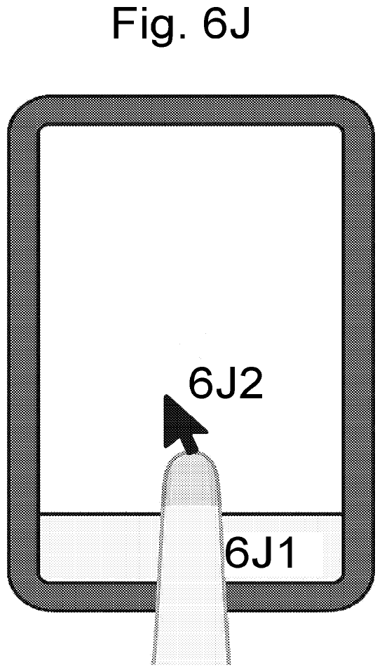

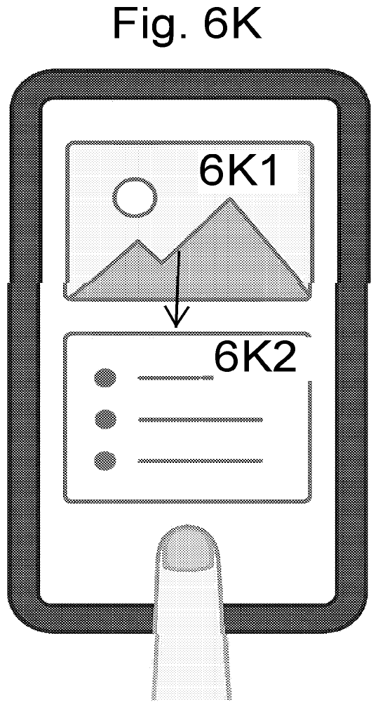

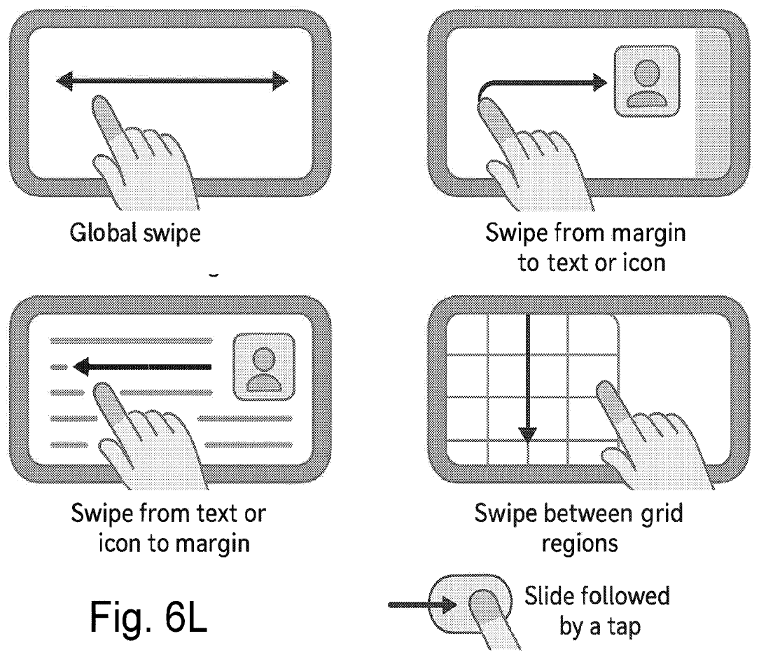

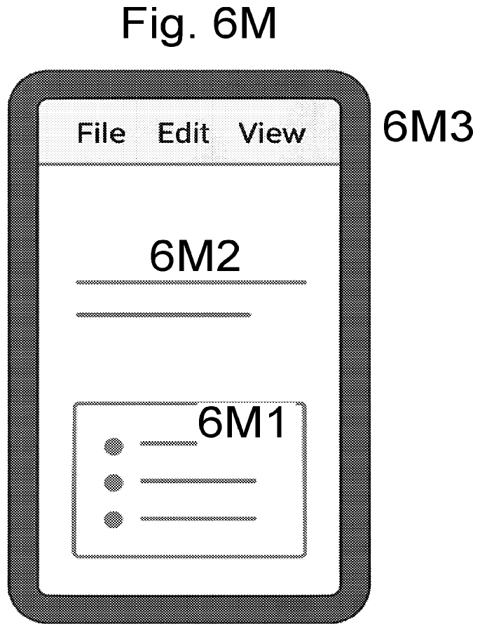

### FIG. 6A—Ereader Embodiment Under Exclusive User-Defined Control

FIG. 6A (eReader) illustrates a non-limiting embodiment of a fundamental phone interface in which text is displayed within left and right margins, a visual form common to messaging, word-processing, email, presentation, and publishing applications, such that a skilled user would recognise—by visual appearance alone—how such interfaces normally operate under manufacturer-defined semantics.

Using the User Input Interface (UII) builder (e.g. FIG. 3), the user may recreate this identical visual appearance while redefining operability exclusively through user-provided specific instructions. Through a hierarchical, vertically scrolling, collapsible menu controlled by slides and swipes rather than taps, the user selects modular interface components, such as a scrolling text module, and determines which operations are enabled.

As a result, two devices may present indistinguishable screens (for example, a document in view mode), yet behave entirely differently: one governed by manufacturer-defined semantics and one governed exclusively by user-defined semantics known only to the user.

In one embodiment:
6A1 the user enables only the scrolling text module and disables tap, pause, selection, and edit semantics, such that vertical scrolling occurs only when the thumb moves within the text region;
6A2 a deliberate swipe from the text region to the right margin toggles scrolling between an active scrolling state and a frozen state, with repetition of the same gesture unfreezing the display;
a compound gesture, such as text-to-margin-to-text, may be required to increase safety against accidental activation.

When scrolling is frozen, the display behaves like a physical book page: touching the text has no effect, the device may be pocketed or held freely with the display on, and any arbitrary portion of the document may be positioned and frozen, providing greater flexibility than a physical book.

Display power control may likewise be user-defined and isolated from content interaction. For example, a vertical downward swipe (or reverse downward-upward-reverse swipe) 6A3 confined to a margin region, such as the right margin extending over approximately one quarter of the screen height, may toggle the display on or off, while vertical movement within the text region continues to perform scrolling. For increased safety, a compound right-angled gesture comprising a horizontal movement from the text region toward the margin followed by a downward movement within the margin may be required.

These gestures are deliberately small, thumb-natural, and located where the thumb naturally rests, enabling efficient one-handed operation with minimal movement. A skilled person would recognise that such behaviour is not possible in existing GUI word processors or messaging applications that rely on operating-system-controlled tap and selection pipelines.

The resulting configuration may be saved as a user-defined embodiment, for example to a USB-C device, such that insertion of the device places the phone into a dedicated, single-purpose reading mode in which only the selected document is accessible and all other graphical user interface operations remain inoperative. Where the content is public-domain (for example, War and Peace), no conventional security is required, allowing an unlimited inoperative wait state, minimal power usage, and precise freezing of the display at the point last read, thereby enabling creation of a fully user-defined, safe, efficient, and highly optimised personal e-reader as a direct consequence of the method of FIG. 1A implemented through the UII builder, with the remainder of the device remaining in an inoperative-as-GUI state.

Alternatively, the configuration may be stored on the device and made selectable through a user-defined menu, for example as described with respect to FIG. 3, in which multiple user-defined configurations are represented as stored specific-instruction profiles. In such embodiments, the configurations may be presented in a scrolling menu and selected using a further user-defined input, such as a hardware-button press, a power-button sequence, or another deliberate input path, causing the device to activate the corresponding user-provided specific instructions. This arrangement avoids the need to carry a removable USB-C device while preserving the ability to select between multiple user-defined configurations stored on the device.

### FIG. 6B—One-Handed Copy-and-Paste Editing (Non-Limiting Embodiment Using User-Defined Input Semantics)

FIG. 6B illustrates a non-limiting embodiment in which the user imports a user-defined reading configuration (e.g. FIG. 6A) via the User Input Interface (UII) builder, placing the device into a safe reading mode in which scrolling is enabled and tap-based editing semantics are disabled.
B01 a deliberate swipe from the right margin toward a word initiates selection of a start word;
B02 a temporary zoom box may appear, permitting optional character-level adjustment of the start point;
B03 a return movement to the right margin confirms the start of the selection;
the user scrolls freely to a desired end point and
B04 performs a second right-margin-to-text swipe to select an end word, with optional zoom-box refinement;
B05 the selected text block remains highlighted and may persist indefinitely for review;
B06 a reverse movement from the highlighted region back to the right margin confirms the selection and completes a copy-and-paste operation, automatically inserting the selected content into an associated notes section (e.g. stored as a related file or as a notes region within the same document, such as a new docn file).

The process may be repeated as required, including capture of a single word or precise character-level selections. All interaction is performed one-handed using small, thumb-natural movements. Navigation actions do not themselves trigger execution, and execution occurs only in response to explicit user-defined input grammars.

A skilled person will recognise that this interaction model is not available in existing graphical user interface word processors, which require mode switching and rely on tap-based selection handles that are easily disrupted by accidental contact. As with FIG. 6A, this embodiment arises directly from rendering existing GUI operating system instructions inoperative as a control authority and replacing them with exclusive user-defined semantics. The configuration may be saved as a reusable reader-and-note-taker profile, for example via the UII builder, without restoring manufacturer-defined GUI behaviour.

### FIG. 6B1—Incremental Extension to Full Editing and AI-Assisted Refinement

FIG. 6B1 illustrates a non-limiting incremental extension in which the safe reading configuration of FIG. 6A and the one-handed copy-and-paste capability of FIG. 6B are extended to support full document editing and refinement, including spelling correction, grammar correction, formatting, and AI-assisted polishing of selected text, without restoring manufacturer-defined GUI operating system control authority or switching between view and edit modes.
B07 after selecting a word or passage as described in FIG. 6B, the user continues a deliberate downward movement originating at the selection;
B08 an editing menu box appears adjacent to the selection, presenting user-defined operations applicable to the selected word, character, or passage, including spelling correction, grammar correction, rephrasing, formatting changes, and AI-based refinement functions, with AI-generated suggestions optionally presented in order of likelihood;
B09 a first menu item enables transition to character-level input, for example by sliding back toward the right margin to invoke the character grammar described in FIG. 6B2;
selection of an operation is performed by continued downward movement, sliding within the menu, or making the menu persistent and scrollable, with expandable submenus permitting access to additional functions;
a swipe from the menu box toward the margin dismisses the menu without executing any operation.

By continuing the downward movement after selecting the end word of a highlighted passage, operations may be applied to entire words, characters, or multi-word selections, including reformatting or AI-assisted rewriting. These operations are introduced as additional user-defined input paths under the same configuration, enabling incremental addition of full editing capability while tap-based interaction and manufacturer-defined semantics remain disabled.

The resulting configuration may be saved as a further user-defined embodiment, for example on a USB-C device or as an extension of the FIG. 6B reader-and-note-taker configuration, allowing selection between reading-only, reading-and-annotation, and full editing and AI-assisted refinement modes, all operating under the same governing principle of exclusive user-defined input semantics.

### FIG. 6B2—Incremental Text Replacement and Integrated Messaging Using a User-Defined Character Grammar

FIG. 6B2 illustrates a non-limiting incremental extension in which the user remains within the document and replaces selected text by character entry, while preserving the one-handed, thumb-only interaction model established in FIGS. 6B and 6B1. This functionality is added without restoring manufacturer-defined editing modes and remains governed exclusively by user-defined input semantics.
B10 after selecting a word or passage as described in FIG. 6B, or invoking the editing menu of FIG. 6B1, and selecting the first menu item B09, the user performs an additional deliberate movement toward the right margin rather than selecting an editing function;
B11 a vertical character strip appears along the margin, presenting characters such as letters, numerals, and commonly used punctuation, with additional characters (e.g. space or frequently used symbols) optionally positioned above, below, or within the strip according to user preference;
characters are selected by vertical thumb movement, with insertion occurring upon lift-off;
B12 an adjacent, scrollable AI-generated suggestion area may appear, presenting context-relevant words, phrases, or corrections derived from surrounding document content, selectable according to user-defined semantics.

The character grammar may also be used to respond to external messages, such as email, messaging, or notifications, without leaving the document. Upon detection of an incoming message, AI-generated reply suggestions may appear in the adjacent suggestion area, enabling the user to select a complete reply with a single movement, insert it into a message context, and immediately resume document editing.

FIG. 6B2 demonstrates that, once existing graphical user interface operating system instructions are made inoperative as a control authority, text replacement, AI-assisted editing, integrated messaging, and system-level control may be added incrementally under exclusive user-defined input semantics, reinforcing that application boundaries themselves are user-defined.

### FIG. 6C—Incremental Integration of Non-limiting Spreadsheet Content and Dynamic Tables

FIG. 6C illustrates a non-limiting incremental extension in which spreadsheet content is imported into a document environment under exclusive user-defined input semantics, without restoring manufacturer-defined application or operating-system control authority.

In this embodiment:
6C1 a deliberate thumb swipe originating from a defined corner region of the display, such as a battery or status indicator region, and terminating beneath a camera region causes presentation of a scrollable horizontal ribbon menu;
lifting the thumb causes a dropdown menu to appear, including an import heading, with selection revealing spreadsheet-related menu items and optional drill-down functions;
6C2 selection of the spreadsheet option causes a secondary scrollable list to appear, presenting available spreadsheet documents or sources;
6C3, 6C4 the user defines placement of the imported spreadsheet content by selecting a top-left reference position and a bottom-right reference position, for example in a page-layout positioning mode, to size and place the spreadsheet within the document;
spreadsheet content may be imported as a complete table or as a selected portion of a spreadsheet, while remaining within the same user-defined input environment established in FIG. 6B2.

The horizontal ribbon may present familiar application-style headings while remaining governed exclusively by user-provided specific instructions. Selection of a heading causes a secondary marginal menu to appear, for example as a vertically scrollable menu positioned along a display margin to support one-handed operation. The ribbon may expose only a restricted subset of operations relevant to the current task, with all other graphical user interface operations remaining inoperative.

Authentication for access to such cross-application functionality may be provided by a user-defined mechanism, including biometric confirmation or public-key selection defined as input data, or may be omitted where no additional authentication is required.

In one embodiment, the import menu presents modular functionality from other applications compliant with the User Input Interface (UII) architecture, enabling partial application functionality to be invoked as data-defined operations rather than launching a separate application. Frequently used or user-defined spreadsheet sources may be presented first.

6C5 following placement, the user may perform a deliberate downward movement from the imported spreadsheet region to invoke an editing menu, providing operations such as updating values, formatting cells, recalculating data, or synchronising the selected portion with its source. These operations are executed as additional user-defined input paths and do not restore manufacturer-defined graphical user interface control authority.

FIG. 6C therefore demonstrates that, through deliberate vertical and horizontal movements defined entirely by the user, content originating from multiple applications—including word-processing and spreadsheet functionality—may be composed within a single document environment as a direct incremental extension of FIG. 6B2, while remaining governed exclusively by user-defined input semantics.

### FIG. 6D—Incremental Creation and Editing of Presentation Content Under User-Defined Control

FIG. 6D illustrates a non-limiting incremental extension in which presentation authoring functionality is added to the document environment established in FIG. 6B2 and 6C, without leaving the document context or restoring manufacturer-defined application or operating-system control authority.

In this embodiment:
6D1 a deliberate slide or swipe originating from a defined corner region of the display, such as a battery or status indicator region, and terminating beneath a camera region causes presentation of a scrollable horizontal ribbon menu;
the user may flick laterally through the ribbon to select a heading, such as an export heading;
starting a swipe on the export heading causes a marginal menu to populate, from which selection of a presentation option converts previously captured notes and document content into a presentation 6D2;
6D3, 6D4 the user defines placement of the presentation content by selecting a top-left reference position and a bottom-right reference position, for example in a page-layout positioning mode;
6D5 a deliberate downward movement while in presentation mode invokes a scrollable presentation-specific editing menu providing additional presentation functions.

The presentation view operates under the same user-defined input semantics as the document and spreadsheet embodiments, enabling editing, formatting, and re-ordering of presentation content using the same margin-based and gesture-based input grammar.

In one embodiment, the presentation editing menu includes a media-import option. Selection of this option presents locally stored images or video, which the user positions on a presentation page using deliberate gesture-based placement, for example by defining a region from a top-left point to a bottom-right point. Default text-wrapping or AI-assisted layout rules may be applied, with further adjustment performed using additional user-defined gestures such as pinch-to-zoom or margin-based scrolling.

As with earlier embodiments, all presentation creation and editing functions are added as further user-defined input paths under the same exclusive control authority, without re-enabling manufacturer-defined GUI semantics.

FIG. 6D therefore demonstrates that presentation authoring may be composed incrementally and modularly on top of document editing, annotation, character entry, AI-assisted refinement, and spreadsheet integration, enabling a unified, one-handed, gesture-based workflow that would not be possible under conventional GUI operating systems requiring application switching and mode-dependent interaction.

### FIG. 6E—Camera Interface and Photo Capture

FIG. 6E illustrates a camera interface under exclusive user control. Camera activation may be invoked from any device state using a deliberate global gesture, such as a right to left edge margin for photo and a right margin, left margin, right margin reverse swipe 6E1, without navigating operating system menus. Photo and video capture may be distinguished by different gesture patterns, with capture triggered by lifting the finger. E.g. right edge to left edge horizontal slide (not shown) causes photo app to appear and lifting after screen trigger photo taking and a right margin to left margin back to right margin reverse swipe 6E1 of the display cause the video mode and lifting off screen triggers video start 6E2. And then using the button 6E3 ends the video. Moving vertically downward or upward in the slide deactivates the taking the picture or starting video e.g. upwards and downward deactivates the photo or video app. Because gestures are deliberate and user defined, capture is fast, stable, and resistant to accidental activation. Also performing this global swipe for photo (right to left margin direction swipe) or video (right to left to right edge reverse margin swipe) can be done in pocket and then holding the thumb one handed can then allow the user compose the photo or video in the app being able to zoom with pinch using left hand and lifting off the screen is the fastest way a photo or video can be started after composition. Minimising missing photos or video.

### FIG. 6F—Video Interface and Video Editing

### FIG. 6F—Incremental Photo and Video Editing Within the Document Environment

FIG. 6F illustrates a non-limiting incremental extension in which photo and video editing is performed while remaining within the document or presentation environment established in FIGS. 6B-6D, without restoring manufacturer-defined media-editing applications or control authority.

In this embodiment:
6F1-6F5 correspond respectively to 6D1-6D5 of FIG. 6D, except that 6F5 invokes media-editing functionality;
when a photo or video appears within a document or presentation page, a deliberate downward movement from the media element invokes a media-specific editing menu;
for a photo, a scrollable editing menu appears beneath the image, providing operations such as cropping, rotation, colour adjustment, filtering, or other photo-editing functions, all executed under user-defined semantics;
where the media element is a video, invocation of the editing operation causes a filmstrip representation to appear beneath a preview frame, with a position marker indicating the current frame;
6F6, 6F7 the user positions the frame marker by deliberate movements, for example by moving upward into the preview area and then horizontally across the filmstrip and downwards, enabling frame-by-frame selection of a desired image;
once a frame is selected, the user may save it or confirm it as the active preview frame; 6F8 for video trimming, the user defines a clip by selecting a start frame and repeating the same interaction to select an end frame, for example by a deliberate movement from a margin of the filmstrip toward a desired end position;
6F9 a further deliberate downward movement from the filmstrip invokes additional editing menus, enabling application of further video-editing functions such as trimming, effects, or formatting.

All media-editing operations are invoked using the same margin-based and directional input grammar described with respect to FIGS. 6A-6D, ensuring consistent one-handed operation and clear separation between navigation, selection, confirmation, and execution.

FIG. 6F therefore demonstrates that photo and video editing may be integrated seamlessly into document and presentation workflows as a direct incremental extension of earlier embodiments, under exclusive user-defined control and without reliance on manufacturer-defined media-editing semantics.

### FIG. 6G—Display On/off and Device Operability Control

### FIG. 6G—Independent Control of Display Power and Device Operability

FIG. 6G illustrates independent user-defined control of display power and overall device operability under the same exclusive user-control architecture.

In this embodiment:
6G1 the display may be turned on or off using a deliberate margin-only downward movement, for example in the right margin, without affecting the underlying device state; a reverse downward-upward movement may optionally be required to reduce accidental activation;
6G2 the user defines a separate operability-control gesture, such as a downward reverse movement in a designated margin region (e.g. the left margin), causing the device to enter a fully inoperative-as-GUI state in which all graphical user interface operations are disabled regardless of displayed content;
6G3 a corresponding upward reverse movement restores graphical user interface operability.

The display-power gestures and operability-control gestures are distinct, require deliberate execution, and are defined as global functions accessible from any screen or interface state. These functions remain available regardless of which user-defined embodiment is active, including those of FIGS. 6A-6F.

This arrangement enables the user to independently select between:
(i) display on with operability enabled;
(ii) display on with all graphical user interface operability disabled;
(iii) display off with operability disabled; or
(iv) display off while preserving the ability to restore display power.

As a result, the user may create a functional equivalent of a lock screen in which all interaction is disabled, even though underlying content may remain visible or the display may be powered off. Importantly, this is achieved without invoking manufacturer-defined lock or security mechanisms and operates consistently across all prior embodiments.

FIG. 6G therefore demonstrates that display state and operability state are orthogonal and independently controllable through user-defined input semantics, allowing any combination of viewing, freezing, disabling, or re-enabling interaction to be performed safely and deliberately under exclusive user control. The non-limiting global functionality of disabling graphical user interface operability may be particularly useful in messaging or video-communication scenarios, such as when a device is temporarily handed to a child, allowing the display to remain active while user input is rendered inoperative and accidental termination or unintended actions are prevented.

### FIG. 6H—User-Controlled Emulation and Redesign of Existing GUI Structures (Non-Limiting Example)

FIG. 6H illustrates a non-limiting example of how the User Input Interface (UII) enables a user to emulate, redesign, and extend existing graphical user interface (GUI) structures—such as web browsers or webpages—while maintaining exclusive user-defined control authority.

In the illustrated configuration, webpage content is presented in one region of the display, while a user-defined, scrollable control menu is presented in an adjacent region. The control menu provides direct access to selected webpage functionality under user-defined semantics, enabling interaction without reliance on the original webpage layout or navigation logic.

The user-controlled interface may access the same underlying webpage or service as a conventional browser interface; however, all appearance, input interpretation, and execution of operations occur exclusively in accordance with user-provided specific instructions, rather than browser- or manufacturer-defined GUI semantics.

Under the UII principle, the user may define global behavioural rules applicable across one to all webpages, including non-limiting examples such as suppression of advertisements, disabling of pop-ups, selective permission of tracking or cookies, and restriction of page elements to user-authorised forms. These rules are enforced while existing GUI operating system instructions remain inoperative as a control authority.

FIG. 6H further illustrates that the user-controlled interface may optionally emulate the observable behaviour of a conventional browser or webpage, while retaining exclusive user control over input interpretation and operation execution. Beyond emulation, the user may redesign interaction models to provide alternative menus, gesture-based controls, or consolidated functional views that exceed prior-art GUI behaviour.

Technical significance: FIG. 6H demonstrates that web interfaces are no longer constrained by manufacturer-defined appearance, navigation, or interaction models. Instead, appearance, input grammar, and execution of one to all operations are governed solely by user-provided specific instructions, as a direct consequence of the change in principle of operation recited in Claim 1.

### FIG. 6I—Global Switching Between User-Defined Interface Control and Emulated Existing GUI Behaviour

FIG. 6I illustrates a global switching function that allows the user to transition between a user-defined interface configuration and an emulation of an existing graphical user interface operating system, and to switch back again, without restoring manufacturer-defined control authority. Because this function is not frequently required and should not be triggered accidentally, it is invoked using a deliberate compound global gesture.

In this embodiment:
6I1 the global switch is activated by a deliberate right-angled reverse movement, for example a downward movement followed by a horizontal movement from the right margin toward a text region at the bottom of the display, then a reverse horizontal movement back to the right margin, and finally an upward movement returning to the starting point;
performing this gesture causes the device to transition from a user-defined configuration to an emulated existing GUI operating system interface;
repetition of the same gesture returns the device to the prior user-defined configuration.

The switching function is defined as a global input path, accessible from any screen or interface state, and may be combined with the global display-power and operability-control functions described with respect to FIG. 6G. This enables the user to temporarily present a familiar emulated interface, for example when handing the device to another person, and then immediately return to exclusive user-defined control using the same global gesture.

6I2 access to the hand-mouse mode illustrated in FIG. 6J is likewise provided as a global function, for example by a deliberate compound gesture comprising a movement from the right margin to the top edge, followed by a horizontal movement and a reverse of that movement to return to the starting position. Because this function is global, it may be invoked from any screen or interface state.

FIG. 6I therefore demonstrates that global switching between user-defined control and emulated prior behaviour may be performed deliberately, reversibly, and safely under exclusive user control, without restoring independent control authority to existing graphical user interface operating system instructions.

### FIG. 6J—Hand-Mouse Precision Interaction Under Exclusive User-Defined Control

FIG. 6J illustrates a hand-mouse interaction mode in which a user-defined global input path causes a first finger movement 6J1 on the display to control a pointer rather than triggering drag, selection, or application-launch events. In this mode, contact of the first finger with the display is interpreted exclusively as pointer positioning, with the pointer rendered offset from the finger to permit precise visual placement of the pointer tip 6J2.

In this embodiment:
6J1 a first finger movement controls pointer position only and does not invoke selection or execution;
additional fingers touching the display invoke click-type operations according to user-defined semantics. For example, in a right-hand grip, touching the display with a finger positioned to the left of the pointer-controlling finger may invoke a left-click operation, while touching with a finger positioned to the right may invoke a right-click operation.

All pointer movement and click-type operations are defined entirely by user-provided specific instructions and do not rely on manufacturer-defined pointer, touch, or accessibility semantics.

This hand-mouse interaction mode is enabled only because existing graphical user interface operating system instructions have been made inoperative as a control authority. In a conventional GUI operating system, a first-finger touch on a display element would immediately trigger selection or application launch, making it impossible for the same input to be interpreted solely as pointer movement. In contrast, under the present architecture, identical physical input data is interpreted exclusively according to user-defined semantics, enabling pointer movement without activation and allowing precise, desktop-style interaction on a touch-based device.

FIG. 6J therefore demonstrates that, once manufacturer-defined GUI control authority is removed, pointer-based precision interaction may be implemented on a touch device in a manner that is structurally unavailable under existing graphical user interface operating systems.

### FIG. 6K—Browser Interface With User-Defined Rendering, Permissions, and Content Control

FIG. 6K illustrates a browser interface operating under exclusive user-defined input semantics, in which rendering, scripting, permissions, and external actions occur only when explicitly enabled by user-provided specific instructions. By default, web content may be treated as purely visual, preventing execution of scripts, advertisements, tracking elements, or external actions unless deliberately authorised by the user.

In this embodiment:
the user selects an internet search or web-import option from a horizontal ribbon menu, for example from the same ribbon used for import and export operations as described with respect to FIGS. 6D and 6F; selection may be performed using a deliberate slide to the relevant heading;
the user may then select from commonly used or previously selected web destinations, or enter initial characters of a website name using the user-defined character grammar described with respect to FIG. 6B2, with matching destinations presented in a scrollable list;
6K1 upon selection, the browser presents a visual representation of the webpage, for example as an image or rendered layout, while remaining governed exclusively by user-defined control;
6K2 a deliberate downward movement from the webpage area invokes a browser-specific control menu beneath the page, enabling the user to selectively enable or disable browser functions.

In one configuration, the user may select a mode in which only textual content is extracted and displayed, with all advertising, tracking, cookies, and executable content removed. This enables safe review, copying, and reuse of web content without exposure to advertisements, background execution, or security risks.

The browser interface of FIG. 6K may be used as a content source for any of the applications described with respect to FIGS. 6A-6J, including word processing, note-taking, presentation creation, messaging, or media workflows. Because all browser behaviour is governed by the same user-defined input semantics and control authority, web content may be imported, reviewed, and reused without leaving the current document context and without restoring manufacturer-defined browser behaviour.

### Backward Compatibility, Trusted UII Interaction, and Networked Operation

Backward compatibility with conventional browser behaviour is supported through user-defined emulation; however, such emulation may be incrementally modified under user control to restrict or eliminate undesirable behaviour. For example, user-defined specific instructions may progressively disable tracking mechanisms, advertisements, cookies, executable content, or other data pathways that could otherwise introduce harmful or unwanted data onto the device. In some embodiments, prior-art browser emulation may be stripped entirely of advertising and tracking functionality while retaining only selected content-retrieval capabilities.

In further embodiments, when a browser instance and a remote website or service are each identified as operating under the User Input Interface (UII) architecture and possess validated, trusted identities, the devices may, by mutual agreement and under explicit user-defined commands, exchange information directly and efficiently. In such configurations, high-bandwidth network connections (for example, fibre connections) allow the remote system to function effectively as a secondary computing resource, invoked and controlled through user-defined input semantics rather than through conventional browser execution models.

Such trusted, direct interaction is available only in embodiments in which user identity has been successfully validated and recognised as trusted. Where illicit or unauthorised behaviour is detected, the exclusive association between user-defined specific instructions and a validated device identity enables rapid attribution of the behaviour to the originating device and instruction set.

This capability further enables coordinated operation across multiple devices. For example, once a user has validated their identity, user-defined configurations may be transferred or made available to other trusted devices within a secure network environment, such as an NHS network. In such embodiments, the user may access protected data or workflows from any authorised device while retaining exclusive control over input semantics, operability, and data pathways, without restoring manufacturer-defined graphical user interface control authority.

These embodiments demonstrate how multiple computing devices may operate cooperatively under the User Input Interface architecture, with user-defined control, identity validation, and modular operability enabling secure, auditable, and efficient distributed interaction that is not achievable under conventional graphical user interface operating systems.

FIG. 6K therefore demonstrates that internet browsing and content acquisition may be incorporated as a controlled, modular function within the User Input Interface architecture, enabling selective access to web content while preserving user sovereignty, security, and consistency with all previously described embodiments.

### FIG. 6—Additional User-Defined Operational Modes

FIG. 6L illustrates further non-limiting operational modes defined entirely by the user, for example as described in Claim 8, reinforcing that all graphical user interface behaviour exists only where, when, and how the user chooses under the User Input Interface (UII) principle.

In the illustrated embodiments, a user may employ interfaces comprising visible icons, text, and invisible regions, together with user-defined gesture paths. Using the UII builder, the user defines specific instructions that assign operations to deliberate input paths rather than to manufacturer-defined tap, pause, hover, or long-press semantics.

Non-limiting examples of user-defined input paths include:
global swipe gestures;
swipes originating from an outside or margin region and terminating on text, an icon, or another visible element;
reciprocal swipes from text or an icon to an outside or margin region;
swipes between defined invisible grid regions, visible regions, or combinations thereof; and
compound inputs such as a slide followed by a tap or other secondary action.

Each such input path is defined by the user as input data and mapped to one or more graphical user interface operations through user-provided specific instructions.

Claim 8 (d1)-(d6) give concrete, claim-friendly examples of input path types; (d7)-(d8) make explicit that the user may define additional input path types—independent of visual appearance and not limited to any particular input modality or operation—while still defining at least one visual appearance, input grammar, and operation under (a)-(c).

In one embodiment, a sliding- and swiping-based interface replaces all tap-based interaction for a given screen or page, such that no operation is triggered by simple contact, pause, or accidental touch of the display surface. This allows the user to rest fingers on the display without risk of unintended activation. Scrolling, selection, invocation, editing, and navigation operations are instead performed exclusively through deliberate, user-defined gesture paths.

These embodiments demonstrate that a single physical input modality, such as touch input, may be redefined in multiple alternative ways through user-provided specific instructions. A person skilled in the art would recognise that, for such behaviour to be possible, existing graphical user interface operating system instructions that define tap-to-launch, long-press-to-move, pause-to-select, or similar semantics must be made totally inoperative as a control authority. If such instructions remained operative, identical physical input could not be rendered neutral where the manufacturer-defined instruction would otherwise trigger an operation.

Accordingly, control authority over graphical user interface interaction must be absolute. The same requirement applies to all input modalities supported by the device, including touch, multi-touch, pointer movement, mouse input, keyboard input, stylus input, voice input, sensor-derived input, or combinations thereof. Any residual control by existing graphical user interface operating system instructions would create conflicting interpretations of the same input data and lead to unstable or erroneous operation.

This total transfer of control authority enables incremental and unrestricted customisation. A user may initially select safer, faster, or more convenient interaction methods and progressively add, remove, or modify further input paths. Because visual appearance is decoupled from operability, an interface that appears identical to an existing graphical user interface provides no indication of how it is operated. Under the UII architecture, each user may select or define visual appearances and interaction models suited to their particular purpose, resulting in a plurality of distinct user-defined interfaces represented as configuration data rather than manufacturer-defined application logic.

To support familiarity and interoperability, a device manufacturer may provide one or more standard emulation configurations corresponding to existing graphical user interface operating systems. Such emulations enable compatibility while remaining subject to the same governing principle of exclusive user-defined control authority. In parallel, users may define task-specific or purpose-specific configurations tailored to professional, educational, or recreational use.

User-defined configurations may be stored, transferred, shared, or distributed as data, enabling reuse across devices and collaborative or community-driven development of interface configurations, while the underlying device architecture remains unchanged.

In some embodiments, the UII builder may incorporate advisory mechanisms, including automated analysis or artificial-intelligence-based guidance, to warn a user of potential consequences of a proposed configuration prior to activation. Such guidance assists decision-making without imposing control authority.

Because interaction with external devices or services occurs only in accordance with user-defined permissions and input semantics, device behaviour may be negotiated explicitly at the point of interaction. This enables precise control over what information is received by the device, what information is disclosed, and under what conditions such exchange occurs, providing enhanced privacy, auditability, and systemic safety.

FIG. 6L therefore demonstrates that, once pre-installed graphical user interface operating system instructions are made totally inoperative as a control authority, users may define interpretation of any available input modality through specific instructions, using graphical configuration tools, scripting languages, configuration files, rule sets, or other user-defined instruction formats. These mechanisms enable interaction grammars that are not available, and not possible, under a conventional graphical user interface operating system prior to removal of manufacturer-defined control authority.

### FIG. 6M—User-Defined Email Interface Under Exclusive Control

FIG. 6M illustrates a user-defined email interface operating under exclusive user-defined input semantics. The figure shows a schematic email interface 6M1 with a scrollable list of received messages 6M2 and a ribbon 6M3.

In this embodiment, reading, composition, and interaction within the email interface reuse the same configurations and input grammars described with respect to FIGS. 6A-6C, including scrolling text, margin-based gestures, and deliberate confirmation actions, without restoring manufacturer-defined email application control authority.

An email message is presented visually within the interface, while attachments, links, scripts, and external actions remain inoperative by default unless explicitly enabled through user-provided specific instructions. This prevents accidental execution of attachments or links and blocks background activity or tracking without deliberate user authorisation.

One or more functionalities described with respect to FIGS. 6A-6K may be selectively imported into the email interface using the same User Input Interface (UII) builder. For example, the user may enable safe scrolling and freeze-page behaviour for reading email content, margin-based selection for copying text into notes or documents, character-based input and AI-assisted reply generation as described with respect to FIG. 6B2, or controlled web-import behaviour as described with respect to FIG. 6K.

As a result, email reading, replying, annotation, and content reuse may be performed within a single user-defined interaction environment, without invoking default email application modes, on-screen keyboards, or operating-system-defined behaviours. All email interaction remains governed by the same user-defined input paths and exclusive control authority as earlier embodiments.

FIG. 6M therefore demonstrates that email functionality may be incorporated as a modular, selectively enabled capability within the User Input Interface architecture, preserving user sovereignty, security, and consistency across document, messaging, browsing, and media workflows.

### Unified Practical Demonstration of the User Input Interface (UII)

The following unified example is illustrative and non-limiting. FIGS. 6A-6M collectively illustrate a single, continuous practical demonstration showing how the User Input Interface (UII) enables construction of a fundamentally different interaction model for a device while preserving familiar visual appearances.

The figures demonstrate that, once existing graphical user interface operating system instructions are made totally inoperative as a control authority (FIG. 1A), a user may incrementally define, remove, and recombine interface functionality in ways that were structurally impossible under conventional GUI operating systems prior to the invention.

Starting from a familiar text-based screen (FIG. 6A), the user recreates an identical visual appearance to conventional applications such as messaging, word processing, email, and document viewing, while entirely replacing the underlying input semantics with user-defined grammars. From this single visual archetype, the user progressively constructs a safe reader, note-taker, editor, media editor, presentation tool, browser, email client, camera interface, and system controller, all under exclusive user control and without restoring manufacturer-defined GUI authority.

### Features Enabled by the Change in Principle of Operation

The following capabilities arise directly from the architectural change implemented by the invention:
Identical appearance, different behaviour
   Two devices may present indistinguishable screens (e.g. a document in view mode) yet behave entirely differently, with operability known only to the user.
Incremental reconstruction of functionality
   The user begins with a fully inoperative interface and selectively adds required operations, progressing from reading (FIG. 6A), to copy-and-paste note-taking (FIG. 6B), to full editing and AI-assisted refinement (FIG. 6B1-6B2), to spreadsheet integration (FIG. 6C), presentation authoring (FIG. 6D), media capture and editing (FIGS. 6E-6F), browser-based content acquisition (FIG. 6K), and email interaction (FIG. 6M).
User-defined input grammars
   All interaction is governed by deliberate, user-defined input paths (margin-based swipes, compound gestures, directional movements), rather than taps, pauses, or operating-system event pipelines.
One-handed, minimal-movement operation
   Interactions are optimised for thumb-natural movements, enabling faster, safer, and less fatiguing operation than conventional touch interfaces.
Separation of navigation, selection, confirmation, and execution
   Accidental activation is structurally eliminated; content may be touched, rested on, or pocketed without triggering operations.
Integrated multi-application workflows
   Word processing, note-taking, spreadsheet editing, presentation creation, media editing, browsing, messaging, and email replying are composed within a single user-defined environment, without application switching or mode changes.
AI as an operation, not a control authority
   AI-assisted spelling, grammar, rewriting, layout, and message suggestions are invoked as selectable operations under user control, rather than as background system behaviour.
Global functions under user control
   Display power, operability lock, emulation switching, camera activation, and hand-mouse pointer control are implemented as global user-defined functions accessible from any screen (FIGS. 6E-6J).
Portable, single-purpose embodiments
   Any configuration may be saved (for example to USB-C media) and re-activated, enabling creation of dedicated devices such as a secure e-reader, note-taker, or presentation editor without conventional lock or security mechanisms.

### Why These Capabilities Were Impossible Under Existing GUI Systems

A person skilled in the art would recognise that none of the above behaviours could be achieved under existing GUI operating systems such as iOS, Android, or Windows prior to the invention, because those systems require manufacturer-defined instructions to remain operative as a control authority. In such systems, a first-finger touch necessarily triggers selection or launch, view and edit modes are enforced by the operating system or application, application boundaries cannot be bypassed, and global gestures cannot override default GUI behaviour.

By contrast, the present invention removes this constraint entirely by transferring GUI control authority from the operating system to the user. The figures therefore do not represent isolated features, but a single practical demonstration of the consequences of changing the governing principle of interaction itself.

FIG. 7 illustrates a non-limiting PHQ-9 task menu in which highest-risk responses may be entered by a single swipe (~0.2 s), compared with approximately one second per item using taps, reducing interaction time and freeing clinician attention for patient care.

### FIG. 8: Embodiment—Emergency Department Workflow Using Dynamic Task Menus

FIG. 8 illustrates an embodiment of the User Input Interface (UII) applied to an NHS Emergency Department workflow. The system doubles clinical efficiency by replacing static graphical user interfaces with dynamic, user driven task menus presented in a structured grid format. Clinicians select a workflow appropriate to their role and context, and interact directly with NHS Spine-connected data, ensuring that every required element is addressed sequentially from the first row to completion.

Data entry is rapid, complete, and auditable. Navigation and review are achieved via invisible scroll regions, touch gestures, mouse, keyboard, or hardware keys (e.g. Y, N, U), with the user retaining full control over preferred input methods to maximise speed and accuracy. Touch optimised controls (see FIG. 4) enable row by row entry, including uncertainty markers and data type specific controls.

Upon completion of clinical findings, AI modules present optimised investigations and treatment options, which may be ordered with a single action. Patient identification is seamless through wristband scanning or NHS App authentication, with full support for paper based workflows during transition phases.

The UII enforces interface consistency while allowing user defined presentation, whether as a grid or formatted narrative history. Editing is protected by deliberate, swipe initiated activation, preventing accidental modification. AI continuously organises captured data, highlights omissions, narrows differential diagnoses, and displays diagnostic commentary directly beneath relevant rows. Patient confirmation and signature fields ensure record accuracy and medico legal robustness.

All recording styles are supported, including grid entry, handwriting, dictation, and stylus input. AI converts free form notes into structured text and suggests clinically relevant additions. Shortened task menus may be deployed for triage, with full assessments completed later by GPs or senior clinicians. Nurses capture baseline observations, doctors review and refine findings, and AI guides investigations and management. This enables clinicians to see up to five times more patients during peak demand, while preserving the capacity for extended, humane care when time allows.

Security and Synchronisation: Security is intrinsic to the system. In some embodiments, authentication may use cryptographic keys combined with biometric methods such as fingerprint or facial recognition, preventing unauthorised access. Devices report available input capabilities, allowing each user to select their preferred configuration. All data is encrypted in transit and at rest, synchronised across devices, and continuously analysed by AI for completeness, safety, research, and outcome tracking at national scale.

### Workflow Steps (Illustrative)

1. Admission and Initial Capture: Patient registration 802, wristband 803 issuance, triage 804, and history and examination in NHS emergency consultation room 814 by clinician 834.

2. Secure Device Activation: Clinician activates device 830, scans wristband 803 or connects via the patient's phone using the NHS app, and retrieves the relevant task menu or menus for the patient.

3. Task Menu Interaction: Touchscreen tablet 832 is used for rapid data entry while maintaining patient engagement, with menus dynamically adapting to prior responses.

4. Adaptive Workflow: Mobile devices may securely commandeer desktops or laptops 838 for printing or extended tasks, with laboratory 840 and imaging 842 systems integrated.

5. Data Quality and Continuity: Symptoms are categorised, unresolved items are flagged, and workflow continuity is maintained across roles and devices.

6. Real-Time Analytics: National synchronisation enables outbreak detection, resource optimisation, and throughput analysis.

7. Security and Legacy Integration: Continuous authentication, device synchronisation, and upgrade paths for legacy systems are supported.

### Summary of Advantages

The embodiment delivers doubled clinician throughput, improved record accuracy, reduced duplication, enhanced patient engagement, and real time national analytics.

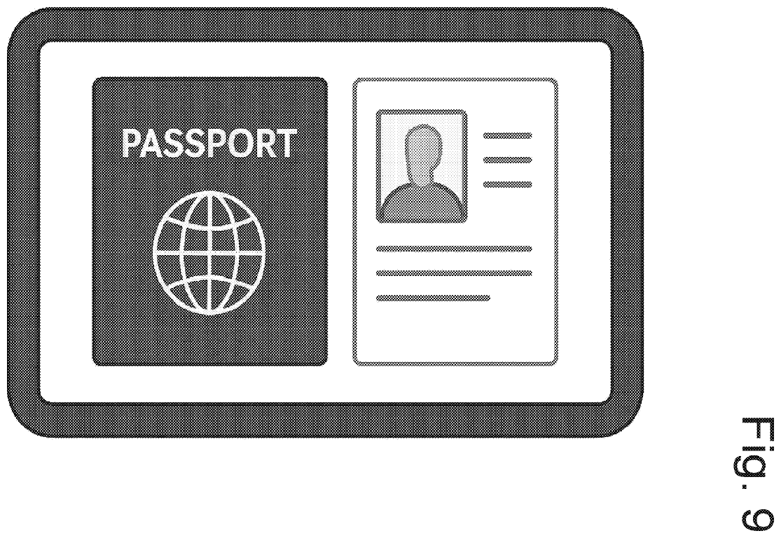

FIG. 9 illustrates that, as a consequence of the User Input Interface (UII) principle, a user may choose to configure the device to function as an electronic passport.

Exemplary nature of FIG. 9. FIG. 9 illustrates an exemplary embodiment in which the device distinguishes a single controlling user by optional identity-related input data provided by the user as part of the specific instructions. In this embodiment, identity verification is used to prevent uncontrolled multi-user access and to enhance safety and accountability. Such identity-based control is one exemplary mechanism for ensuring single-user control and is not required by Claim 1, which encompasses embodiments in which the controlling user is distinguished by other specific instructions (e.g. user-defined gesture-based single-user control)

In some embodiments, the device is inoperative as a graphical user interface until single-user control is validated. Optionally further user defined identity data may be provided for enhanced security. This clarifies the user retains control over all personal data stored on the device, while an external authority, such as a passport office, independently holds the official identity data required for passport issuance.

Using the UII builder, the user may grant permission for the device to share selected public key information with the passport authority. The passport authority may likewise provide its corresponding public key information. As a result, the device and the passport authority can mutually verify each other without either party relinquishing control over their respective data.

Because graphical user interface operability may be chosen by the user to be dependent on successful identity validation, the device cannot be used by an unauthorised person. This makes the device suitable for use as a trusted identity credential, including as an electronic passport, and enables verification by both the passport authority and the device user. The same mechanism may be used to support related identity dependent services, such as healthcare identification, without restoring manufacturer defined graphical user interface control authority.

### FIG. 10—Exemplary Device State Under the User Input Interface (UII) Principle

### Exemplary Nature of Non Limiting Identity-Based Embodiments (FIGS. 10, 11, and 9)

FIGS. 10 and 11 illustrate exemplary, non-limiting embodiments in which user-provided specific instructions include, in addition to configuration data, optional identity-related data supplied by the user as an input of data. In these embodiments, identity verification is performed as an optional mechanism to distinguish a single controlling user and to enhance security, policy enforcement, or accountability prior to execution of graphical user interface operations.

Such identity-based verification is not required by Claim 1 and does not limit its scope, but represents one exemplary manner in which user-provided specific instructions may be structured to provide a secure and auditable implementation of the User Input Interface architecture. Other embodiments may distinguish the controlling user by different means, or may omit identity verification entirely, while remaining fully within the scope of Claim 1.

### Exemplary Device Architecture (FIG. 10)

FIG. 10 illustrates an exemplary device (1200) implementing the User Input Interface (UII) governing principle and showing the end-to-end control flow by which graphical user interface operability is transferred from manufacturer-defined operating system instructions to exclusive user-defined control.

The illustrated device comprises:
1201 existing graphical user interface operating system instructions that would ordinarily interpret user input and trigger graphical user interface operations;
1202 a control boundary rendering the instructions of 1201 totally inoperative as a control authority;
1203 non-GUI device instructions remaining operative, including power management, charging, storage access, cryptographic functions, internal comparisons, and validation logic;
1204 one or more input components detecting user input events without default graphical user interface effect;
1205 user-provided input data source containing configuration data and, in some embodiments, identity data;
1206 internal validation function for comparing received identity data with stored identity references, where optional identity validation is employed;
1207 user-defined instruction execution environment activated upon satisfaction of user-defined enablement conditions, including user-defined configuration requirements and, where used, optional identity validation;
1208 a graphical user interface operation execution path controlled exclusively by user-provided specific instructions.

FIG. 10 demonstrates that the device may remain powered and capable of internal processing while remaining inoperative as a graphical user interface until user-defined configuration requirements (and, where used, identity requirements) are satisfied.

### End-to-End Operational Description (With Reference to FIG. 10 and FIG. 11)

FIG. 10 illustrates the complete operational lifecycle of a device operating under the User Input Interface (UII) principle.

At block 1201, the device includes existing graphical user interface operating system instructions that would ordinarily interpret user input, dispatch events, and trigger graphical user interface operations. In accordance with Claim 1(i), these instructions are not removed but are rendered totally inoperative as a control authority.

At block 1202, a control boundary prevents those instructions from interpreting input or invoking graphical user interface operations, thereby placing the device into an inoperative-as-GUI state. The device may remain powered, and static visual output may be present, but no graphical user interface operation can occur under manufacturer-defined semantics.

At block 1203, non-GUI device instructions remain operative. These include power management, charging, storage access, cryptographic functions, internal comparisons, and validation logic. The device therefore remains functional at a hardware and system level while remaining inoperative as a graphical user interface.

At block 1204, input components detect user input events. Because existing graphical user interface operating system instructions remain inoperative as a control authority, these inputs are treated as neutral data and have no default graphical user interface effect. This input-neutral wait state may persist indefinitely unless and until valid user-provided specific instructions are received, as further illustrated by the method flow of FIG. 11.

The first meaningful user action under the UII principle is an explicit election to take control of the device. This election is itself an input of data and does not rely on any existing graphical user interface semantics. If no such election occurs, the device remains in the inoperative-as-GUI state defined by blocks 1201-1204.

At block 1205, the device receives user-provided input data. This input data may include identity data, confirmation data, and configuration data supplied through a user input interface, external storage, or other permitted input channels. As illustrated in FIGS. 1D and 2, identity data may be supplied by swipe-based colour selection, sequences of reference inputs, numeric or pixel-value data, biometric-assisted confirmation, or insertion of a removable storage device such as a USB-C device. This identity input is processed purely as data and does not itself cause any graphical user interface operation.

At block 1206, an internal validation function compares received identity input data against stored identity references using non-GUI device instructions. Validation may include cryptographic comparison, biometric matching, or reference-value correlation. If validation fails, the device remains inoperative as a graphical user interface and no GUI operation can occur.

At block 1207, upon successful validation, a user-defined instruction execution environment is activated. This execution environment operates independently of the existing graphical user interface operating system instructions, which remain inoperative as a control authority. In this state, access to a User Input Interface (UII) builder, as illustrated in FIG. 3, may be provided to allow the user to define specific instructions governing visual appearance, operative inputs, and execution of one to all graphical user interface operations.

The output of the UII builder is configuration input of data represented by a configuration identity value. Identity data and configuration data are distinct and independently verifiable. Configuration data may be stored internally, stored on removable media such as a USB-C device (FIG. 1D), or transferred between devices to enable portability of user-defined configurations.

At block 1208, graphical user interface execution is comparison-gated at the operation level. In some embodiments, for each graphical user interface operation that would otherwise occur, validated user identity data is compared with configuration identity data. If the comparison fails, no GUI event is dispatched. If the comparison succeeds, execution is permitted solely in accordance with user-provided specific instructions. This enforcement may be continuous and applied on a per-operation basis rather than only at login.

Once the required configuration data (and, where used, identity data) are validated, the device becomes operative as a graphical user interface under exclusive user control. One to all graphical user interface operations may be executed, but only through user-defined specific instructions. Existing graphical user interface operating system instructions do not regain independent control authority, even where user-defined semantics emulate prior graphical user interface behaviour.

### Accessibility, Portability, and Removable Provisioning (FIG. 1D)

In an accessibility and portability example illustrated by FIG. 1D, identity data and configuration data may be stored on a removable USB-C device, for example for a blind user. Insertion of the device itself constitutes user input of data and does not require visual interaction or reliance on screen state. Upon insertion, configuration data and optional identity data are validated using the same comparison-gated mechanism described with respect to blocks 1205-1208, enabling consistent and repeatable operation across multiple devices without reliance on sight, gestures, or manufacturer-defined graphical user interface behaviour.

### Further Consequence for Manufacturers

As a further consequence of the change in governing principle, the invention is beneficial to device manufacturers. Existing graphical user interface operating system instructions need not be discarded or rewritten. Instead, those instructions may be rendered inoperative as a control authority and selectively re-expressed, where desired, through user-defined specific instructions operating within the User Input Interface architecture.

Manufacturers may therefore adapt existing systems into UII-compatible devices with minimal additional programming effort, shifting focus from maintaining complex, monolithic input-interpretation pipelines to providing stable execution environments and UII configuration tools. This enables compatibility with existing visual appearances through optional emulation, reduces long-term maintenance complexity, and supports a cooperative model in which manufacturers supply robust platforms while users define how their devices operate under exclusive user control.

FIG. 11 illustrates an exemplary, non-limiting operational flow defining the governing principle of operation under the User Input Interface (UII) architecture, including optional elements.

In the illustrated flow:
1401 existing graphical user interface operability instructions are made totally inoperative as a control authority; • 1402 the device enters an inoperative-as-GUI state, in which no user input triggers graphical user interface operations under manufacturer-defined semantics; • 1403 the device optionally receives user identity data as an input of data, in embodiments employing identity-based enforcement of single-user control; • 1404 the device optionally validates the received identity data;
1405 the device receives user configuration data defining user-provided specific instructions;
1406 a user-defined instruction execution environment is activated upon satisfaction of user-defined enablement conditions, including optional successful identity validation where used;
1407 subsequent inputs are interpreted exclusively according to user-defined input grammars;
one to all graphical user interface operations are executed exclusively in accordance with user-provided specific instructions;
1409 prior graphical user interface behaviour may optionally be emulated under user control without restoring manufacturer-defined control authority; and
1410 the device may optionally re-enter the inoperative-as-GUI state under a user-defined policy.

Technical significance: FIG. 11 depicts the two-stage transfer of control authority—first disabling manufacturer-defined graphical user interface operability instructions, and then enabling graphical user interface operation exclusively through user-provided specific instructions—resulting in exclusive, single-user governance of graphical user interface behaviour under the UII principle.

### Enablement and Full-Scope Disclosure of Consequences

This specification enables the full scope of the principle change by describing:
(i) which instructions must be rendered inoperative—namely, graphical user interface operability instructions that interpret input relative to display appearance and trigger GUI operations;
(ii) the resulting device state, including an inoperative-as-GUI condition with input neutrality;
(iii) the forms of user-provided input data, including identity, confirmation, and configuration data; and
(iv) execution of graphical user interface operations exclusively under user-defined semantics.

The consequential benefits disclosed herein arise directly from the architecture. Security benefits result from removal of default manufacturer-defined event semantics and corresponding shared attack surfaces. Customisation benefits result from user-defined control authority over input grammars and operation mappings. Efficiency benefits arise from direct mapping of reference inputs to operations and from gesture grammars that capture multiple actions. Error-prevention benefits result from neutral input behaviour in the inoperative-as-GUI state and from optional confirmatory actions under user-defined semantics.

The invention is therefore not a modification of a conventional graphical user interface, but a change in the governing principle by which a device becomes operative as a graphical user interface and by which graphical user interface operations are governed at execution.

### Additional Implementation Variations and Non-Limiting Options

In further embodiments, the device supports multiple user-defined operating profiles, each profile comprising identity rules and configuration modules. A user may select a profile through a reference input, and the device may load only the modules required for that profile, thereby reducing the operative code surface and limiting active functionality to what is explicitly required.

In some embodiments, user-provided specific instructions define a policy layer that restricts which operations may occur in response to which inputs. The policy layer may specify categories of operations, confirmation requirements, and allowable communication pathways, all under user-defined control. Such policies may be expressed as data structures, rule tables, or scripted constraints.

In some embodiments, the device supports staged operability. In a first stage, only a limited subset of graphical user interface operations is enabled, for example to allow safe configuration or update of user-defined instructions. In a subsequent stage, additional operations may be enabled. Transition between stages may be conditioned on additional confirmation data.

In some embodiments, the device supports a recovery mode in which user-defined identity data and configuration data may be restored from secure backup. Recovery mode remains consistent with the governing principle by maintaining existing graphical user interface operating system instructions inoperative as a control authority.

In some embodiments, the device supports peripheral-specific validation. For example, a user may define that a particular external keyboard, pointing device, or accessory is permitted as an input source only when its identifier matches a user-defined reference value.

In some embodiments, the device supports auditing of user-defined configuration changes. Audit records may be stored locally and may record which configuration modules were active when particular operations were executed. Such auditing is optional and defined by the user.

These variations demonstrate that a wide range of implementations may realise the same change in governing principle while remaining within the scope of the invention. Unless expressly stated otherwise, dependent and independent claims following Claim 1 describe optional embodiments or alternative formulations and do not limit the scope of Claim 1, which is fully enabled and defined by the disclosure as a whole.

1. A device, comprising:
(a) a processor;
(b) a memory storing executable instructions; and
(c) a display screen or a display component,
wherein the processor, upon execution of the executable instructions, is configured to:
(i) make existing instructions of an existing graphical user interface (GUI) operating system totally inoperative as a control authority, thereby making the device inoperative as a GUI; and
(ii) receive specific instructions provided only by a user as input data, and, without requiring any existing GUI operating system instruction to interpret, dispatch, or execute GUI operations as a control authority, execute the specific instructions to configure and make operative one to all GUI operations of the device.

2. The device of claim 1, wherein making the existing graphical user interface operating system instructions totally inoperative as a control authority comprises at least one of:
(a) interposing a control boundary at event dispatch;
(b) interposing a control boundary at graphical user interface framework interpretation;
(c) interposing a control boundary at graphical user interface operation invocation;
(d) preventing an existing graphical user interface event dispatch system from invoking graphical user interface operation handlers;
(e) preventing existing graphical user interface frameworks from receiving input events as operative events;
(f) blocking manufacturer defined graphical user interface semantics until user defined enablement conditions are satisfied and user defined semantics are active;
(g) marking a graphical user interface operability instruction pathway as inactive at boot time such that the device cannot present an operative graphical user interface under manufacturer defined semantics;
(h) ensuring, after disablement, that no residual manufacturer defined instruction regains control authority for interpreting input and executing graphical user interface operations; and
(i) causing detected user input events, while the existing graphical user interface operating system instructions are inoperative as a control authority, to be treated as neutral data that do not trigger any graphical user interface operation by default.

3. The device of claim 1, wherein the specific instructions provide full control of configuring and executing all operations solely by the user, including control of at least one visual appearance of the display screen whether powered on or off, control of any input to the device, and control of how one to all operations of the GUI are executed.

4. The device of claim 1, wherein the specific instructions define a scope of functionality that is not less than the scope of functionality of the existing graphical user interface operating system.

5. The device of claim 1, wherein the user provides the specific instructions as an input of data comprising one or more binary data values in the form of pixel values, text, numeric values, or data derived from user defined inputs to the device, or combinations thereof.

6. The device of claim 1, wherein the specific instructions reduce the number of user interaction steps required to execute at least one graphical user interface operation compared with an existing graphical user interface operating system.

7. The device of claim 1, wherein the specific instructions define at least one visual appearance, input, or operation of the graphical user interface, and may optionally include user defined identity related data for distinguishing or validating a controlling user, wherein such identity related data, when present, forms part of the user provided specific instructions and does not restore control authority to pre installed graphical user interface operating system instructions.

8. The device of claim 1, wherein the user provided specific instructions define, for at least one configuration of the graphical user interface:
(a) at least one visual appearance of the display in a powered on or powered off state;
(b) an input grammar that maps inputs received via a user input interface to one or more graphical user interface operations; and
(c) execution of the one or more graphical user interface operations according to user defined semantics while the pre installed graphical user interface operating system instructions remain inoperative as a control authority,
wherein the user defined semantics optionally emulate behaviour of an existing graphical user interface operating system or application without restoring control authority to the pre installed graphical user interface operating system instructions, and wherein the user provided specific instructions permit incremental modification of the emulated configuration, including as little as a single change to an operation, an input, or a visual appearance, while the pre installed graphical user interface operating system instructions remain inoperative as a control authority;
and wherein the input grammar includes at least one user selectable input path type comprising a deliberate touch or pointer movement defined as input data by the user, the input path type comprising one or more of:
(d1) a global swipe;
(d2) a swipe originating from an outside or margin region of the display and terminating on text, an icon, or another visible interface element;
(d3) a swipe originating from text, an icon, or a visible interface element and terminating at an outside or margin region of the display;
(d4) a swipe between defined invisible grid regions or between a grid region and a margin, header, footer, or identifier region;
(d5) a swipe or slide between two visible regions including text to text, text to icon, icon to text, or text to control movements, including movements between a main body region and a page identifier, header, footer, menu, or margin resident control;
(d6) a compound input comprising a slide followed by a tap or another user defined secondary action;
(d7) a user defined input path type performed independently of a particular visual appearance or interface layout and defined as input data by the user; and
(d8) a user defined input path type comprising a combination of one or more input modalities and/or reference values defined as input data by the user for assignment to one or more graphical user interface operations;
wherein a user input interface builder provides, via a selectable menu, one or more user selectable input path types for assignment to one or more graphical user interface operations as part of the user provided specific instructions, and wherein the user input interface builder permits the user to define additional input path variations that are not available or not possible under a pre installed graphical user interface operating system before the pre installed graphical user interface operating system instructions are made inoperative as a control authority;
and wherein the description of the input path types is non limiting, and the user provided specific instructions may define interpretation of any input modality available to the device, including one or more of touch, multi touch, pointer movement, mouse input, keyboard input, stylus input, voice input, sensor derived input, or combinations thereof, such that control authority over interpretation of all inputs is governed exclusively by the user provided specific instructions;
and wherein the user input interface builder is not limited to a graphical configuration tool, but may be implemented by any mechanism operable to define the user provided specific instructions, including one or more of a scripting language, configuration files, programmatic definitions, rule sets, or other user defined instruction formats, such mechanisms performing the functional role of the user input interface builder, while the pre installed graphical user interface operating system instructions remain inoperative as a control authority.

9. The device of claim 1, wherein the user-provided specific instructions configure a grid-based user interface comprising a task menu, in which:
(a) task items are arranged as rows; and
(b) selectable options and/or input controls are arranged as columns,
wherein the task menu is visible or invisible and is operable, under the user-defined semantics, using at least one of a touch-sensitive component, a pointing device, and a physical keyboard.

10. The device of claim 9, wherein the task menu is vertically scrollable to access previously entered rows and to reveal subsequent rows representing further task items to be entered, wherein absence of input for a row is treated as an uncertainty value according to a user-defined policy, and wherein a processing module operating under the user-provided specific instructions:
(a) updates a narrative view derived from entries made in the grid-based user interface; and
(b) updates suggested subsequent task items and/or actions based on the entries, including automatically inserting externally obtained results into corresponding rows to refine subsequent suggested subsequent task items and/or actions.

11. The device of claim 1, wherein user input data is independent of current GUI state or visual appearance.

12. The device of claim 1, wherein backward compatibility with existing GUI behaviour is provided by user-defined emulation.

13. The device of claim 1, wherein the display screen or display component is touch-sensitive and provides a user input interface for receiving the input data.

14. The device of claim 1, further comprising a nontransitory computer readable storage medium storing instructions which, when executed by the processor, cause the device to perform the operations recited in claim 1.

15. The device of claim 1, wherein the device comprises at least one of a mobile phone, a tablet, a laptop, or a desktop computer.

16. The device of claim 1, wherein the executable instructions further cause the processor to perform a method comprising:
(i) making existing instructions of an existing GUI operating system totally inoperative as a control authority, thereby making the device inoperative as a GUI; and
(ii) receiving specific instructions provided only by a user as input data, and, without requiring any existing GUI operating system instruction to interpret, dispatch, or execute GUI operations as a control authority, executing the specific instructions to configure and make operative one to all GUI operations of the device.

17. The device of claim 16, wherein the method further comprises at least one of the features recited in claims 2 to 12.

18. The device of claim 1, wherein, for at least one screen or page configuration, a sliding-based and swiping-based interface replaces tap-based interaction such that no graphical user interface operation is triggered by simple contact, pause, or accidental touch of a display surface, and wherein scrolling, selection, invocation, editing, and navigation are performed exclusively through deliberate user-defined gesture paths.

19. The device of claim 1, wherein the user-provided specific instructions define interpretation of any input modality available to the device, including one or more of touch, multi-touch, pointer movement, mouse input, keyboard input, stylus input, voice input, sensor-derived input, or combinations thereof, such that control authority over interpretation of inputs is governed exclusively by the user-provided specific instructions.

20. The device of claim 1, wherein a user input interface builder provides, via a selectable menu, one or more user-selectable input path types for assignment to one or more graphical user interface operations as part of the user-provided specific instructions, and permits the user to define additional input path variations that are not available or not possible under a pre-installed graphical user interface operating system before the pre-installed graphical user interface operating system instructions are made inoperative as a control authority.
